(19) United States
(12) Patent Application Publication
(10) Pub. No.: US 2026/0265479 A1
(43) Pub. Date: Sep. 10, 2026

(54) HIGH-STRENGTH AGRICULTURAL FOAM

(71) Applicant: Brekland Incorporated, Brooklyn, NY (US)

(72) Inventors: Eric BELLEFROID, Brooklyn, NY (US); Philip Andrew Patrick BRUNDNICKI, Brooklyn, NY (US)

(21) Appl. No.: 19/489,175

(22) PCT Filed: Jun. 3, 2024
(86) PCT No.: PCT/US2024/032295

§ 371 Date: Dec. 1, 2025

Related U.S. Application Data
(60) Provisional application No. 63/505,886, filed on Jun. 2, 2023.

(51) Int. Cl. C08J 9/30; A01G 13/00; C08J 3/24; C08L 1/26; C08L 5/00; C08L 5/04; C08L 5/08; C08L 29/04; C08L 89/00; C08L 89/06; C08L 97/00

(52) U.S. Cl. CPC C08J 9/30; A01G 13/00; C08J 3/24; C08L 1/26; C08L 5/00; C08L 5/04; C08L 5/08; C08L 29/04; C08L 89/00; C08L 89/06; C08L 97/005; C08J 2205/044; C08J 2301/26; C08J 2305/00; C08J 2305/04; C08J 2305/08; C08J 2329/04; C08J 2389/00; C08J 2389/06; C08J 2397/00; C08L 2201/06; C08L 2203/14; C08L 2312/00

(57) ABSTRACT

The present disclosure provides hydrogel foam compositions with high mechanical strength and methods of protecting plants by applying the hydrogel foam compositions to the plants. The present disclosure particularly provides foamed hydrogel compositions comprising a polymer solution and a crosslinker solution, which can be useful as a new modality of crop protection.

### CROSS-REFERENCE TO RELATED APPLICATIONS

This application is a U.S. National Stage Application filed under 35 U.S.C. § 371 of International Application No. PCT/US2024/032295, filed Jun. 3, 2024, which claims the benefit of priority to U.S. Provisional Application No. 63/505,886, filed on Jun. 2, 2023, which is herein incorporated by reference in their entirety.

### FIELD

The present disclosure relates to hydrogel foams with high mechanical strength and methods of protecting plants by applying the hydrogel foam to the plants.

### BACKGROUND

Agricultural crops face a wide range of environmental and pest pressures that can impact yield and crop quality, resulting in potentially significant economic losses if left unprotected. These may include various abiotic factors such as smoke, sun exposure, and frost, as well as numerous biotic factors such as fungi and insects.

Ameliorating these abiotic and biotic factors present significant challenges to farmers and current crop protection systems are often inadequate.

Consequently, there is a great need in the art for alternative crop protection systems that do not suffer from the drawbacks present in current systems, and which offer a new modality of protection.

### SUMMARY OF THE DISCLOSURE

The present disclosure solves the problem facing the agricultural community, by providing hydrogel foams with high mechanical strength, which have application, inter alia, in crop protection.

The hydrogel foams of the present disclosure provide a new modality of protection that is greatly needed in the agricultural sector.

The present disclosure provides a foamed hydrogel composition, comprising: (a) a polymer solution, (b) a crosslinker solution, and (c) compressed gas capable of foaming a hydrogel into a foamed hydrogel.

In some embodiments, a functional group of the polymer is selected from the group consisting of —NH2, —COOH, and —OH. In some embodiments, the polymer is a naturally derived polymer or a synthetically derived polymer.

In some embodiments, the polymer is selected from the group consisting of polyvinyl alcohol, protein, lignin, denatured collagen, chitosan, starch, alginate, pectin, carrageenan, and cellulose. In some embodiments, the lignin comprises oxidized derivatives of lignin. In some embodiments, the lignin comprises kraft lignin, alkali lignin, and lignosulphonate. In some embodiments, the protein includes soy and whey protein, and their hydrolyzed derivates (i.e., hydrolyzed derivates of soy protein and hydrolyzed derivates of whey protein). In some embodiments, the carrageenan comprises kappa carrageenan, iota carrageenan, or lambda carrageenan. In some embodiments, the cellulose comprises ester or ether derivates. In further embodiments, the ether derivatives of cellulose comprises carboxymethyl cellulose, hydroxypropyl methyl cellulose, methyl cellulose, or hydroxyethyl cellulose.

In some embodiments, the crosslinker is a chemical crosslinker. In some embodiments, a functional group of the crosslinker is aldehyde or carbodiimide. In some embodiments, the aldehyde functional compound comprises glutaraldehyde (GTA) or glyoxal. In some embodiments, the carbodiimide functional compound comprises 1-Ethyl-3-(3-dimethylaminopropyl) carbodiimide. In other embodiments, the crosslinker is a physical crosslinker and is selected from the group consisting of a metal ion. In some embodiments, the metal ion is selected from the group consisting of Ca²⁺, Mg²⁺, Zn²⁺, Sr²⁺, Cu²⁺, Fe²⁺, Ba²⁺, Al³⁺, Cr³⁺, and Fe³⁺.

In some embodiments, the hydrogel has a water content of about 80% to about 99% by weight, when gas porosity is less than 1%. In some embodiments, the foamed hydrogel has a gas porosity of about 50% to about 99% by volume. In some embodiments, the foamed hydrogel has gas bubbles with an average diameter of about 0.1 mm to about 5 cm.

In some embodiments, the crosslinker readily reacts with the polymer to form a covalent bond in ambient conditions from about −10° C. to about 40° C. and relative humidity between about 10% to 100%. In some embodiments, the polymer and the crosslinker have a reaction half-life of 1 second to 600 seconds.

In some embodiments, the hydrogel has a polymer concentration of about 1% to about 10% by weight, about 0.5% to about 5% by weight, about 0.1% to about 2% by weight, about 3.5% to about 10% by weight, about 2% to about 7.5% by weight, about 3.5% to about 15% by weight, about 3.5% to about 25% by weight.

In some embodiments, the hydrogel has a crosslinker concentration of about 1% to about 10% by weight, about 0.1% to about 1% by weight, about 0.1% to about 3.5% by weight, about 0.1% to about 5% by weight, about 1% to about 5% by weight, or about 1% to about 15% by weight, when gas porosity is less than 1%.

The present disclosure provides a method of protecting a plant from an abiotic stressor, comprising: applying the hydrogel composition taught herein to the plant or area in which the plant is growing. In some embodiments, the abiotic stressor is at least one selected from the group consisting of smoke, sun exposure, and frost.

The present disclosure provides a method of protecting a plant from a biotic stressor, comprising: applying the hydrogel composition taught herein to the plant or area in which the plant is growing. In some embodiments, the biotic stressor is at least one selected from the group consisting of a fungus, a bacterium, a pathogen, an insect, and a pest.

The present disclosure provides a method of generating a foamed hydrogel, comprising: (a) providing a polymer solution comprising water and a polymer; (b) providing a crosslinking solution comprising water and a crosslinking agent; and (c) mixing the polymer solution, the crosslinking solution, and a gas to form a foamed mixture. In some embodiments, step (c) is performed by (i) mixing the polymer solution with a compressed gas and (ii) mixing the compressed gas-polymer solution with the crosslinking solution. In other embodiments, step (c) is performed by (i) mixing the polymer solution with the crosslinking solution; and (ii) mixing the polymer-crosslinker solution with compressed gas. In further embodiments, step (c) is performed by (i) mixing the crosslinker solution with a compressed gas; and (ii) mixing the compressed gas-crosslinker solution with the polymer solution.

In some embodiments, the mixture is applied to a portion of a plant within 1 second to 500 seconds after the polymer solution and the crosslinker solution are mixed to form the foamed mixture.

The present disclosure provides a method of protecting a plant from an abiotic or biotic environmental stressor, comprising: applying to a plant, or area where a plant is growing, a hydrogel composition comprising: (a) a polymer solution (b) a crosslinker solution.

The present disclosure provides a method of preparing a polymer solution concentrate, comprising: (a) blending water and a polymer and (b) containing the solution in a resistant package that is transport and storage resistant.

The present disclosure provides a method of preparing a crosslinker solution concentrate, comprising: (a) blending water and a crosslinker and (b) containing the solution in a resistant package that is transport and storage resistant.

### BRIEF DESCRIPTION OF THE DRAWINGS

FIGS. 1A-1B are schematic depictions of methods of producing a hydrogel of the disclosure. FIG. 1A depicts an embodiment of the disclosure where the crosslinking has slow reaction kinetics. FIG. 1B depicts an embodiment of the disclosure where the crosslinking has rapid reaction kinetics.

FIG. 2 is a schematic depiction of a method of applying the hydrogel foam of the disclosure to a plant (e.g., Vitis vinifera).

FIG. 3 is a chart depicting the temperatures in the south-west of France from April 6^{th} to April 8^{th}, year 1 during the spring frost disaster of year 1. Temperatures are recorded from the Bergerac airport, France.

FIG. 4 is a schematic comparison of different frost protection technologies and their advantages and disadvantages.

FIG. 5 is a schematic depiction of the primary functional groups that a selected group of polymers each has.

FIGS. 6A-6F are a series of images that show the ability for foamed hydrogels to hold onto a ¼ inch wooden dowel set 4 cm from a 70° from vertical slick vinyl board after different crosslinking times, and for different concentrations of glutaraldehyde (GTA). All samples have a chitosan concentration of 1% by weight. FIG. 6A shows an unstable foam within 10 minutes when no GTA is added. FIG. 6B shows stable foamed hydrogels formed after 5 minutes when 0.1% GTA is in solution. FIG. 6C shows stable foamed hydrogels formed after 3 minutes when 0.2% GTA is in solution. FIG. 6D shows stable foamed hydrogels formed after 2 minutes when 0.3% GTA is in solution. FIG. 6E shows stable foamed hydrogels formed after 1 minute when 0.5% GTA is in solution. FIG. 6F shows stable foamed hydrogels formed after 30 seconds when 1% GTA is in solution.

FIGS. 7A-7D are a series of images that show the ability for foamed hydrogels to hold onto a ¼ inch wooden dowel set 4 cm from a 70° from vertical slick vinyl board after different crosslinking times, and for different concentrations of chitosan. All samples have a glutaraldehyde concentration of 0.3% by weight. FIG. 7A shows unstable foamed hydrogels with 0.25% chitosan in solution. FIG. 7B shows stable foamed hydrogels formed after 10 minutes when 0.5% chitosan is in solution. FIG. 7C shows stable foamed hydrogels formed after 2 minutes when 1% chitosan is in solution. FIG. 7D shows stable foamed hydrogels formed after 1 minute when 1.5% chitosan is in solution.

FIG. 8 is a chart depicting the temperature at the center of two 10 cm long and 6 cm in diameter foamed hydrogel cylinder (Foam 1 and Foam 2), compared to the temperature of a freeze chamber over the course of a freeze test (Air temperature 1 and Air temperature 2).

### DETAILED DESCRIPTION

### Definitions

While the following terms are believed to be well understood by one of ordinary skill in the art, the following definitions are set forth to facilitate explanation of the presently disclosed subject matter.

The term “a” or “an” may refer to one or more of that entity, i.e. can refer to plural referents. As such, the terms “a” or “an”, “one or more” and “at least one” are used interchangeably herein. In addition, reference to “an element” by the indefinite article “a” or “an” does not exclude the possibility that more than one of the elements is present, unless the context clearly requires that there is one and only one of the elements.

Reference throughout this specification to “one embodiment”, “an embodiment”, “one aspect”, or “an aspect” means that a particular feature, structure or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics can be combined in any suitable manner in one or more embodiments.

As used herein, in particular embodiments, the terms “about” or “approximately” when used in conjunction with numerical values and/or ranges generally refer to those numerical values and/or ranges near to a recited numerical value and/or range. In some instances, the terms “about” and “approximately” may mean the value plus or minus a range of 10%. The terms “about” and “approximately” may be used interchangeably.

As used herein, the term “hydrogel” refers to a solid like material composed of a three-dimensional network of polymers that hold a minimum of 10% water by weight. In embodiments, the hydrogel comprises a polymer and a crosslinker. As used herein, the term “foamed hydrogel” refers to a hydrogel with a dispersed gas phase forming either closed and, or open celled gas vesicles within the hydrogel.

As used herein, the term “natural polymer” refers to polymers which have natural sources, and may or may not, have been modified, including the addition or removal of the polymers functional groups.

As used herein, the term “biodegradable” refers to a substance that may be broken down into smaller components by bacteria, fungi and other living organisms.

As used herein, the term “compressed gas” refers to a gas, or a mixture of gasses, which are at a pressure above ambient.

As used herein, a “crosslinker” refers to a small molecule or ion that interacts with a polymer to form a bond. A crosslinker is typically smaller than the polymer and thus acts as a connector to link polymers together.

As used herein, the term “chemical crosslinker” refers to a small molecule which has a minimum of 2 functional groups per molecule that will readily react with a polymer to form a covalent bond. As used herein, the term “physical crosslinker” refers to a crosslinker that can form non-covalent bonds, including but not limited to ionic bonds, hydrogen bonds, hydrophobic repulsion and physical entanglement.

As used herein, the term “kinetics” is used interchangeable with chemical reaction kinetics, and refers to the rates and thus speed of chemical reactions.

Agricultural crops face a wide range of abiotic and biotic environmental factors that can impact yield and crop quality. A few of these factors are discussed below.

### Smoke

For growers of fruit that are to be fermented into alcoholic beverages (e.g., wine), smoke damage can pose a significant economic risk. Wildfires can generate large amounts of smoke and aerosols that can drift into agricultural cropland. During wildfires, the combustion of lignin during the burning of wood releases volatile phenols into the atmosphere, such as cresols and syringols. During wildfire events, smoke can drift from the fire affected area towards agricultural production areas. When fruit is exposed to smoke and these volatile phenol compounds, the volatile phenols can penetrate the skin of the fruit and bind with sugars in the fruit to form glycoside-“bound” phenols that stay in the fruit until harvest. Following the harvest of the fruit and during the fermentation of the fruit, the glycoside-“bound” phenols that are within the fruit will remain with the fruit juices throughout the fermentation process and can impart unwanted flavors to the alcoholic beverage, generating what is often referred to as “smoke taint”. This problem is costly, as it may require that the fruit be used for another lower value use (e.g., fruit juice), or that the fruit be discarded entirely.

Most solutions aiming to solve the challenge of smoke taint focus on removing or reducing the impact of the smoke taint after exposure to smoke. Two approaches are typically employed, (a) Careful harvesting and fruit processing techniques to reduce the amount of glycoside-“bound” phenols that are released into the crushed fruit juice, and (b) Use of additives during the fruit juicing and fermentation process to remove some or all of the glycoside-“bound” phenols that are in the fruit juice. For example, hand harvesting of grapes has been found to reduce the risk of smoke taint by minimizing the amount of non-grape material, which might have high glycoside-“bound” phenols, that is introduced into the fruit crushing phase. In another example, activated carbon has been blended into grape juice tanks after grape crushing, but prior to fermentation. The activated carbon can bind a portion of the glycoside-“bound” phenols in the grape juice, the activated carbon was then separated from the juice reducing the phenols in the grape juice. Overall, these solutions can aid in reducing the risk of smoke taint, but are typically expensive, require operational changes to implement and only show moderate results.

Some attempts have been made to try and prevent volatile phenols from being adsorbed into fruit flesh during exposure to smoke through the application of protective layer to fruit. Trials using plastic bags to cover and isolate fruit from smoke have shown to be successful to eliminate the risk of smoke taint contamination in fruit, however these have primarily been to show the viability of coating fruit as a protection mechanism as plastic bags are impractical as a scalable solution. Trials of commercially viable products have focused on sprayable coatings. For example, kaolin, a clay-based barrier coating that is typically used to protect grapes from sun damage, has been applied to grapes to protect them from smoke taint. Results have thus far been mixed, three challenges appear to limit the feasibility of existing sprayable products, (a) existing sprayable solutions may not form a continuous barrier, (b) the coating may also bind volatile phenols and if not properly removed be blended into the juice during juicing, and (c) the high cost of material to form a thick enough coat. The result has been that to date, commercially available solutions to solve smoke taint have been limited to post-exposure removal techniques rather than protective methods.

The present disclosure provides that foamed hydrogel can offer several unique advantages to mitigate this challenge, (a) foam has a high air porosity thus generating a sufficiently thick coating to protect the fruit can be done relatively cost effectively, (b) applying a thicker coating of foam lowers the risk of cracks or non-continuous coverage, and (c) as the foam is generated from a liquid formulation, it's easy to include a phenol chelator or an agent that ensure phenols are not to be bound, whichever is shown to be more effective. Foamed hydrogel shows promise as a smoke taint solution for fruit growers.

### Sun Exposure

For growers of fruit for consumption as a fresh product, and for certain transformed fruit products (e.g., wine), sunburn is a significant risk with the potential for severe economic impacts. Sunburn is a physiological disorder that affects the visual and organoleptic properties of fresh fruit. Excessive exposure to high temperatures, UV radiation and photosynthetically active radiation, can cause damage to the surface of the fruit and cause the plant to respond in a variety of ways to protect itself from further damage. The combination of these factors can lead to visual imperfection on the surface of the fruit, reducing the potential value of the fruit for sale as high-valued fresh product, and it can also lead to a reduction in the quality of the fruit for processing purposes. For instance, in grapes meant for use in white wines, sunburn can lead to an accentuation of undesirable tasting notes, including an increase in smoky flavors and a reduction in fruity notes, leading to a reduction in the value of the resulting wine.

Different techniques have been utilized to protect fruit, but each technique typically only focuses on a single risk factor (e.g., high temperatures, UV radiation). To combat high temperatures, growers have irrigated fields with water to cool fruit and surrounding air. This has proven effective, however consumes significant volumes of fresh water and does little to protect crops from UV radiation and photosynthetically active radiation. To combat UV radiation, growers have sprayed crops with kaolin solutions, a natural opaque clay that can adhere to fruit and reflect radiation to reduce damage. Similar to the use of irrigation for heat, kaolin and other coating sprays protect against radiation but offer little protection from high temperatures.

The present disclosure provides that foamed hydrogel can offer several unique advantages to mitigate this challenge, specifically that it may be capable of solving several issues at once. Spraying fruit with foam offers two degrees of protection, (a) as an insulator the foam can reduce the temperature of the fruit relative to the surrounding air, and (b) the foam can shield the fruit from radiation, both UV and photosynthetically active radiation. Additionally, other opacity enhancers that block different radiation bands can be used to further increase protection against UV radiation, photosynthetically active radiation, or both. Foamed hydrogel shows promise as a sun protection solution for fruit growers.

### Frost

In yet another example, for growers of high-value commercial crops such as grapes, citrus fruit (e.g., oranges, lemons) and apples, frost presents a significant risk of economic damage. In early spring when crops begin to bud and blossom, short overnight frost events where temperatures reach below 32° F. for several hours, can lead to devastating crop damage.

Growers employ a combination of active and passive protection systems to protect crops against damage from frost. Passive methods include site selection (e.g., sloped hill), crop row orientation, installation of wind barriers including planting trees or installing windbreaks, and selection of more frost resistant crop varieties. In many instances, passive frost protection methods may not be enough, thus growers are increasingly utilizing active frost protection systems, which require activity and recurring costs on the part of the grower to protect the crop.

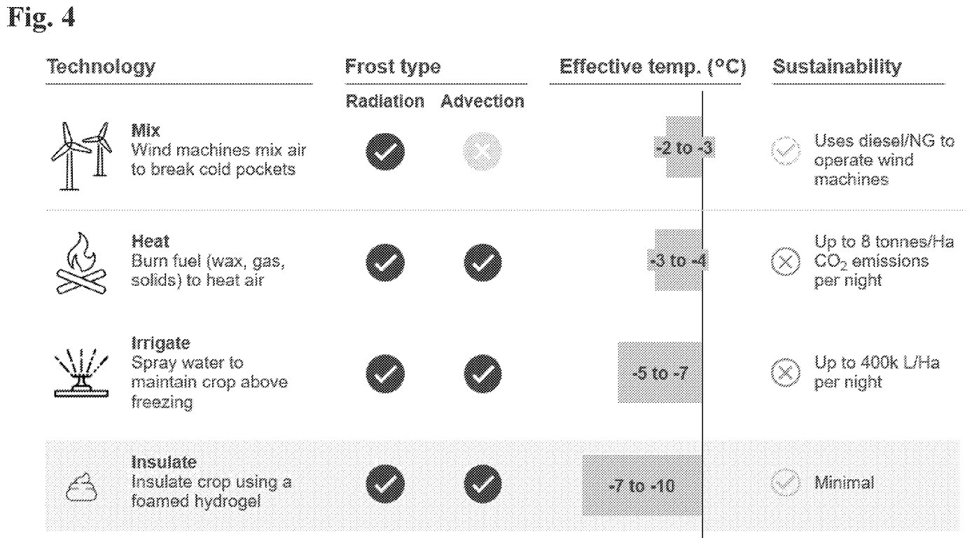

There are two approaches to actively protecting crops from frost; one approach is to actively increase the temperature of the air surrounding the crop, the second is to create a boundary to separate the frost sensitive parts of crops from cold or cooling air. Active heating is the most commonly use technique with three systems in common use; (a) mixing air using a wind machine to break up cold sinks, (b) warming air by using active heaters, and (c) warming the crop and surrounding air by spraying water onto crops either through irrigation or with portable sprayers. All three systems can be effective but have limitations. Mixing air requires costly wind turbines, which only works for radiation frosts with steep inversion layers and only provide 3-5° F. (1.7-2.8° C.) of warming. Warming air requires significant amounts of fuel to burn—typically fossil fuels—and thus is often too expensive for most growers and is highly polluting. Irrigation based protection consumes significant quantities of water, however, this is often no longer viable for many agricultural regions as water shortages become more common. Advantages and disadvantages of different frost protection technologies are presented in FIG. 4.

The alternative to actively heating crops and surrounding air is to create a boundary to separate the frost sensitive parts of crops from cold and cooling air. One approach utilized in several commercially available systems uses plastic or other rigid materials to cover crops and form a warm air pocket beneath the material boundary. However these systems are typically expensive and too labor intensive to be used extensively with most commercial crops. Another approach uses foam to create an insulating barrier on crops. Foams that have a sufficient air fraction can provide excellent thermal insulation characteristics, and, if sufficiently (i.e., thickness and continuousness) applied to plants, can effectively seal and protect crops from freezing conditions. The method of application of foams for frost protection typically consists of a combination of the following steps: a chemical foaming concentrate is diluted with water to form a foaming solution, the foaming solution is placed into a mobile foaming applicator or apparatus, the foaming solution is aerated to form a foam, the foam is applied to a portion of a plant to form a boundary with surrounding air. Foams applied using this, or similar methods, have shown promise in field testing to protect crops, however existing systems have major deficiencies and have thus been largely limited to niche markets such as protecting horticultural crops or some low-lying crops such as strawberries and lettuce.

Two characteristics define foams effectiveness in protecting crops, (a) insulation endurance—specifically a foam's ability to remain stable for long periods of time and maintain its insulation and barrier forming capacity. This includes its ability to withstand various external and environmental forces (e.g., wind, dry conditions). (b) Rheological properties—specifically, as it relates to a foam's mechanical strength, which will determine if the foam is strong enough to hold onto the plant when at a thickness that provides sufficient insulation. Prior innovations have focused on improving foam persistence (i.e., longevity and stability), primarily by adding chemical additives to the foam concentrate that improve foam bubble stability. These additives include water-soluble surface-active polymers, metal salts that form metal-ligand bonds with water soluble polymers, and different surfactant combinations. There have also been attempts to improve persistence by adding chemical additives that adsorb water and improve the foams' resistance to dry environments and high winds.

Despite extensive research, prior foams have poor rheological properties, consisting of an aqueous foam that flow similarly to a liquid, and thus have insufficient mechanical strength to hold onto standing crops or trellised crops (e.g., apples, grapes). Due to this, the use of foams have been largely limited low-lying crops (e.g., strawberries, lettuce).

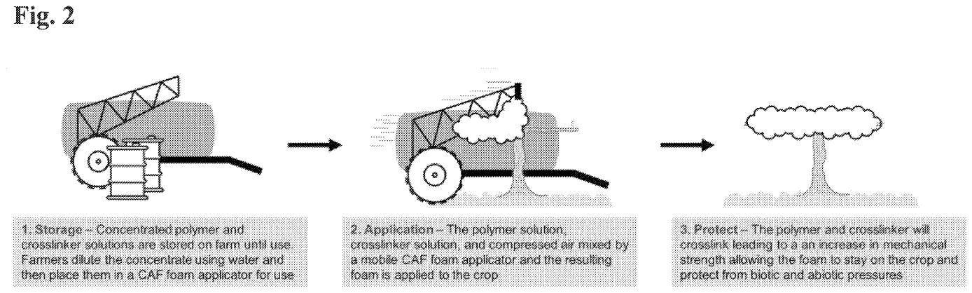

The present disclosure provides that foamed hydrogel can offer several unique advantages to mitigate these challenges, (a) the hydrogel enables a higher mechanical strength such that the foam can hold onto standing or trellised crops in sufficient thickness to protect the crop from frost, (b) the improved foam endurance allows the foam to protect crops for several hours to days, and (c) the hydrogel enables the foam to endure a broader range of external pressures such as wind, light rain and high daytime heat. A method of applying the hydrogel foam of the disclosure to a plant or a crop is depicted in FIG. 2.

### Fungal Pressure

Another example of external pressures for growers of high-value commercial crops such as grapes is fungal infections, such as downy mildew. This fungus spreads through the release of spores from infected dead leaves. The fungus attacks a new host by landing on and penetrating the fruit or leaves, where it then begins to reproduce inside the plant. Left unchecked, fungal attacks weaken plants, which significantly reduces fruit quality and yield and even sometimes leads to death.

Growers combat fungal pressures using a combination of passive and active methods. Passive methods are typically a combination of cultivation practices that help to limit the propensity of conditions that encourage fungal growth and reduce the likelihood for fungal spores to spread and propagate. These include canopy and foliage management to reduce humid conditions, double pruning to reduce the risk of fungal infiltration in fresh cuts, and removal of potential fungal spreaders (e.g., infected wild plants) in and around vineyards.

Active methods rely exclusively on the use of fungicides, sprays which kill fungi and their spores. As fungicides typically don't have long residence times, effective prevention of fungal outbreaks requires continuous re-application of fungicides throughout the growing season, which is both expensive and introduces potential environmental side-effects due to the toxic nature of fungicides. Alternatively, farmers have explored covering crops with a barrier coating that inhibits the penetration of fungi into the plant. However, this approach remains relatively limited and is difficult to apply, as its continuous coverage is critical for effectiveness.

The present disclosure provides that foamed hydrogel can offer several unique advantages to mitigate this challenge, (a) foamed hydrogel can form a protective barrier over plants which remains thin enough to allow sunlight to penetrate, (b) as hydrogel is an aqueous medium, pesticides can be incorporated into the solution and remain active for longer periods of time, and (c) as foam has a high porosity it can be applied liberally decreasing the risk of cracks for spores to pass through and keeping costs reasonable due to the low material requirements.

### Insects

Similar to fungal infections, insects can attack crops through a variety of means, decreasing the yield and quality of fruit, impacting many growers of high-value crops, such as peaches, blueberries, and grapes. Some examples of leaf and fruit damaging insects include the grape-berry moth, grape-flea beetle and redbanded leafroller, adult and larval stages of insects, which can consume the leaf, flower and fruit flesh. To combat this, insects are commonly actively managed, typically through the application of insecticides. Applied either as a preventative measure or during an outbreak, growers will spray an insecticide effective against the target insect, ensuring broad application throughout the plants canopy to kill any live insects. However, since outbreaks may only affect small portions of a field, they are challenging to identify and locate, and thus, preventative applications are often necessary to manage insect pressures. As insecticides are typically contact killers and do not offer residual protection following application, thus, multiple preventative applications are often necessary to ensure low insect pressure throughout the season

Alternative methods have been attempted in the past to mitigate insect pressures. For example, thin netting covering either the whole plant, or just the fruit, have been effective preventative measures to reduce the threat of flying insects. However, this approach is labor intensive and impractical for most crops, especially larger tree species such as apples, peaches or pears. Barrier forming applications that coat leaves or fruit, including coating containing insecticides, could be an effective remedy, however no current commercial product of this type has seen widespread use to date.

The present disclosure provides that foamed hydrogel can offer several unique advantages to mitigate this challenge. First, the foam hydrogel can form a protective barrier over plants which remains thin enough to allow sunlight to penetrate. Second, as hydrogel is an aqueous medium, pesticides can be incorporated into the solution and remain active for longer periods of time. Lastly, as foam has a high porosity, the material requirements for this are relatively low, which keeps costs reasonable.

### Foamed Hydrogels

The present disclosure comprises a method of generating, and the composition of, a foamed hydrogel that will coat a part of a plant to protect components of the plant from various external pressures specified above. The method of this disclosure centers around, (a) the innovative concept of using hydrogel as a foam matrix, (b) generating said hydrogel shortly before its application onto plants, and (c) the use of non-toxic and degradable polymers in the formulation.

In order to protect crops from or mitigate the impact of the range of abiotic and biotic environmental factors listed above, there are several material property and operational factors that must be achieved. Though individual properties or methods have been described in the prior art, the disclosed combination of formulation and method of use has not. Foam is used in a variety of applications in agriculture, including as a field marker, in washing or cleaning crops during harvest, and some previous attempts have been made to use foam as a frost protective coating. However, in these previous applications, foams had poor mechanical properties, and/or poor longevity, making them of little use for the applications listed above. Similarly, hydrogels are used extensively in food processing and food science and have been used in agriculture as soil amendments and seed coatings, however these use cases focus on the hydration properties of the hydrogel rather than the insulation and mechanical properties. Finally, a critical requirement for the use of hydrogel in agriculture is that it remain non-toxic and biodegradable with limited impact to the surrounding environment. Spray-on foamed systems, which are used in a range of industries, often utilize polyurethane foams, which rely on toxic solvents and are not biodegradable, making them not suitable in agricultural applications. The combination of water soluble, non-toxic and biodegradable is not found in previous art. These properties and factors are discussed in more detail below.

### Agricultural Foam

Aqueous foams have found use in agriculture in several forms. The most common commercial use today is as a temporary marker, or tracer, where, for example, the foam is deposited on the ground to demarcate where pesticides have been previously applied and where they have not. Another use is as a pest management tool. In one example, foam heated to a high temperature is applied to undesirable plants, burning the leaves or other parts of the plant, the foam allows for high area coverage to coat large portions of the plant, but it's high air fraction enables it to have a low thermal mass meaning the heat dissipates rapidly after application. In another example, a pesticide solution is foamed, which improves the pesticide contact with target pests, such as plants or insects, and reduces the risk of off-target application, improving safety and reducing waste. In another use case, there have been attempts to use foam as a frost protective coating, however this has had limited commercial success to date. As noted above, foams for frost protection in previous studies have insufficient mechanical strength, which limits their use to crops on the ground or as a very thin layer offering limited protection.

In the foam-use cases listed above, previous studies have exclusively used a single solution application, where formulation components, or a formulation concentrate, are mixed with water to form a single solution, compressed gas or a blowing agent is then added to this solution to generate a foam, and the foam is applied to the crop or field. In using the single solution, the advantage is that these foams may use existing commercially available foam application equipment. However, it means that the mechanical strength of the foam is limited by the viscosity of the foaming solution prior to air injection. For instance, patent AU2004319107B2, which discloses a formulation for a frost protection foam specifically noted that “the water dispersion can have a relatively low viscosity so that it can be readily sprayed in conventional commercial spray systems”.

In an embodiment of this disclosure, the present disclosure teaches that the foam is a combination of two solutions and compressed gas, which allows for the use of chemicals in each solution that may react and change the properties of the solution once mixed. In order to achieve this, this disclosure must utilize a new formulation approach and method of application, which has not been employed in agriculture.

### Application to Crops

To be applied to agricultural crops, an embodiment of the foam must meet certain specifications that ensures that the foam will not have negative impacts for the plant, or the surrounding environment. The specific concern is biodegradation of the foam in natural environments. In agricultural environments, which may include fields with planted crops, harvested forests, water bodies downstream of agricultural fields and harvested forests, and settings downwind of agriculture field and harvested forests, degradability of the foam is necessary to ensure that the foam does not persist in the environment, causing harm or having undesirable impacts. Harm or undesirable impacts can include blocking sunlight and reducing plant's ability to grow, trapping nutrients and reducing plant's ability to find sufficient nutrients, being consumed by wild or domestic animals and insects causing harm or death to these animals or insects, or reducing a local areas beauty impacting tourism or property value.

Foam degradation is primarily controlled by the polymer, as the polymer typically makes up the backbone and bulk of the structure. For most foams, once the polymer begins to breakdown, the structure will collapse, allowing for the degradation of the foam into smaller peptides and molecules of its components, eventually reaching microscopic sizes. An embodiment of the foam must be composed of a polymer that is biodegrade in natural environments within a sufficient time to not impact the environment, which is typically within weeks to a year. In some embodiments, the foamed hydrogel is biodegraded within hours, days, weeks, months, or years. In further embodiments, the foamed hydrogel is biodegraded within 1 hour, within 2 hours, within 3 hours, within 4 hours, within 5 hours, within 6 hours, within 12 hours, within 1 day, within 2 days, within 3 days, within 4 days, within 5 days, within 6 days, within 1 week, within 2 weeks, within 2 weeks, within 3 weeks, within 4 weeks, within 1 month, within 2 months, within 3 months, within 4 months, within 5 months, within 6 months, within 7 months, within 8 months, within 9 months, within 10 months, within 11 months, within 12 months, within 1 year, or within 2 years.

In one embodiment of the foam, the biodegradable polymers are naturally derived, and include, but are not limited to, a selection of proteins such as soy and whey protein, lignin, denatured collagen, chitosan, starch, alginate, pectin, carrageenan, or cellulose. In another embodiment of the foam, the biodegradable polymer includes, but is not limited to, a water-soluble synthetic polymer, such as polyvinyl alcohol.

In one embodiment of the foam, synthetic polymers include, but are not limited to, polyethelyne glycol (PEG) and polyacrylamides. In another embodiment of the foam, synthetic polymers, such as, polyethelyne glycol (PEG) and polyacrylamides may not be included, as their degradation rely on abiotic processes such as oxidation or UV radiation, which is very slow with the potential to then build-up in natural environments over time.

### Hydrogels Mechanical Properties

Hydrogels are three-dimensional networks of water-insoluble polymers that hold a large quantity of water and can be tuned to switch between liquid-like state to solid-like state with a broad range of mechanical properties. These unique and diverse properties are of utility in a variety of industries and applications including medical uses such as soft contact lenses and tissue and joint implants, and pharmaceuticals such as slow or triggered-release formulations. A problem to be solved by the present disclosure was to improve the mechanical properties of the foam, whereby the transition from a liquid-like state to a solid-like state, commonly known as gel formation, will increase the mechanical strength of the foam, improving the foams ability to hold onto crops and withstand environmental pressures such as wind.

Foamed hydrogels are hydrogels with a gas phase trapped within the hydrogel forming closed or open celled gas vesicles. Due to their rheological behavior, foamed hydrogels require that the gas be emplaced during the liquid phase prior to gel formation. However, the mechanical strength provided by the hydrogel is necessary to ensure that the foam holds and remains on the plant. A problem to be solved by the present disclosure is the emplacement of the foamed hydrogel onto the crop, such that the solution can both be adequately aerated to generate a foam, and that the foam have sufficient mechanical strength to be emplaced and hold onto the crop. To achieve this, an embodiment of the foam is generated by combining a (a) compressed gas, (b) a polymer solution and (c) a crosslinking solution, which is then applied as a mixture to the crop. In an embodiment of this disclosure, the compressed gas will form small bubbles in the solution, while the crosslinker and polymer will combine, increasing the solution viscosity and modifying the molecular structure through chemical and physical interactions until the foam reaches a solid-like state within 600 seconds allowing it to hold onto the crop.

The key to this disclosure is using a crosslinker and polymer combination with rapid crosslinking kinetics where the reaction allows for a rapid increase in viscosity and mechanical strength to allow the foamed hydrogel to entrap the gas and hold onto the plant. In an embodiment of the disclosure, the crosslinker and polymer must react to allow the formed hydrogel to reach sufficient strength within 600 seconds.

In some embodiments, the crosslinker and polymer react to allow the formed hydrogel to reach sufficient strength within 1 hour, within 30 minutes, within 25 minutes, within 20 minutes, within 15 minutes, within 10 minutes, within 9 minutes, within 8 minutes, within 7 minutes, within 6 minutes, within 5 minutes, within 4 minutes, within 3 minutes, within 2 minutes, within 1 minute, within 60 seconds, within 55 seconds, within 50 seconds, within 45 seconds, within 40 seconds, within 35 seconds, within 30 seconds, within 25 seconds, within 20 seconds, within 15 seconds, within 10 seconds, within 9 seconds, within 8 seconds, within 7 seconds, within 6 seconds, within 5 seconds, within 4 seconds, within 3 seconds, within 2 seconds, or within 1 second.

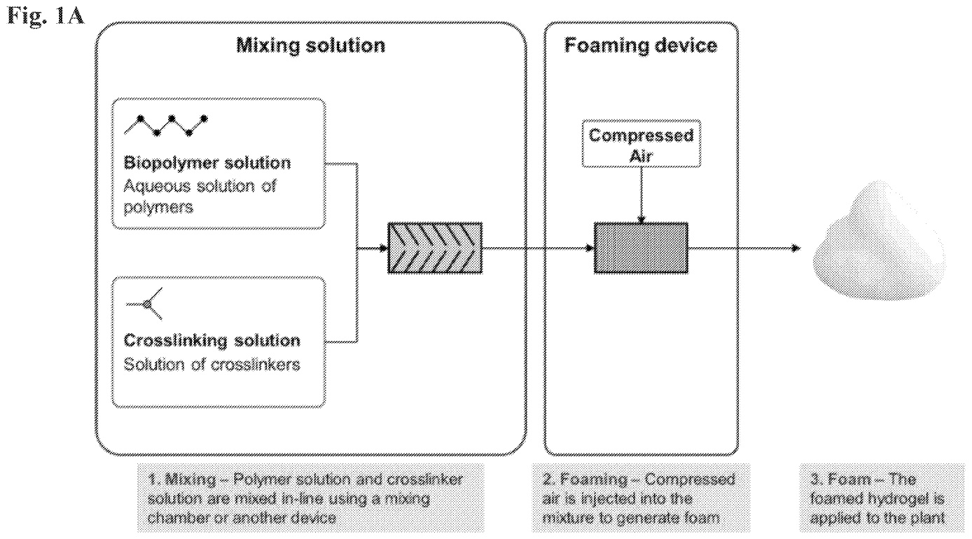

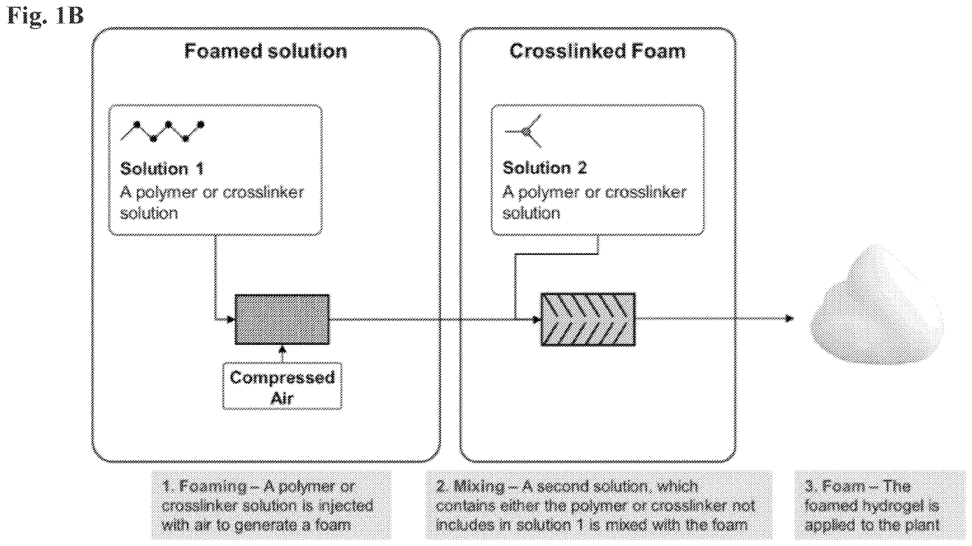

The mixing sequence, whether gas is added to the crosslinker solution, the polymer solution, or a mixture of the two, depends on the crosslinking rate. As described in FIG. 1B, a crosslinker and polymer combination with a rapid crosslinking reaction may require that the compressed gas be emplaced before the combination of the crosslinker and polymer, while slower reactions may allow the homogenization of the crosslinker and polymer prior to the addition of compressed gas as presented in FIG. 1A.

The mechanical strength of the resulting hydrogel will be broadly determined by the bond strength of each connection formed between the crosslinker and polymers, and the bond density of the resulting crosslinker and polymer solution. In the present disclosure, the crosslinker was undersaturated in reactive groups compared to the polymer reactive groups in solution, thus the bond density is primarily a function of crosslinker concentration. The bond strength will be determined by the type of bond. The crosslinks which bond the polymer of a hydrogel form two distinct classifications, physical hydrogels and chemical hydrogels, with several sub-classification each.

The reaction kinetics will be broadly defined by the reaction rate constant of the polymer-crosslinker combination and the concentration of the polymer and crosslinker. Solution pH, temperature and additional solution additives, such as salts or non-reactive polymers, can modify the reaction kinetics as well. This disclosure focuses on polymer and crosslinker reactions that are rapid, with reaction rate constants that allow for a reaction half-life that are less than 60 minutes. In some embodiments, a half-life of the polymer and crosslinker reactions is less than 50 minutes, less than 40 minutes, less than 30 minutes, less than 20 minutes, less than 10 minutes, less than 5 minutes or less than 1 minute. Factors such as concentration, temperature, solution pH and additives can be used to modify the reaction kinetics to achieve the increase in viscosity and mechanical strength at the desired time.

To combine both speed and strength, the present disclosure focuses on two types of polymer-crosslinker bonds, covalent bonds and ionic bonds. Chemical hydrogels are defined by having covalent cross-linking bonds between polymer strands. Though there are exceptions (e.g., thiomers crosslinked via disulfide bonds), chemical hydrogels are almost exclusively irreversible, leading to more mechanically strong and stiff hydrogels as deformation beyond some stretching requires that the polymer, or the crosslinker, be broken. Chemical hydrogels are initiated by the reaction of functional groups with complementary reactivity where the reaction is initiated by mixing two solutions. Given their high reactivity, the two functional groups typically cannot be held in the same solutions and thus must be kept separate until ready to react. There are some exceptions to this, mainly UV-triggered and some thermosetting examples, such as acrylate-based resins. Due to their covalent bonds, chemical hydrogels are mechanically stiffer and more brittle, and are far less likely to deform. Physical hydrogels are defined by having non-covalent crosslinking bonds between polymer strands, typically a combination of hydrogen bonds, ionic bonds, hydrophobic interaction and physical entanglement among others. Hydrogel strength varies widely due to the wide range of bond strength, however ionic bonds are in most cases the strongest of the physical hydrogel bonds. The present disclosure focuses on three types of bonds which are described in more detail below.

### Foamed Hydrogels Components

In order to achieve the desired performance targets, an embodiment of the foam must meet certain specifications. In an embodiment, the foam should have: rapid gelation, high porosity, a hydrogel matrix, the mechanical strength to hold onto a ¼ inch thick branch, and be biodegradable.

Foamed hydrogels are composed of three or more critical chemical parts that function together. These are a polymer, a chemical crosslinker, and a compressed gas capable of foaming a hydrogel into a foamed hydrogel. In some embodiments, foamed hydrogels are composed of (i) three critical chemical parts that function together and (ii) a surfactant. In further embodiments, additional additives may be used to provide additional functional properties, including fats or secondary/tertiary surfactants to improve foam stability and functional properties and polymers to improve water retention and modify viscosity. In order to meet the specifications outlined above, inventors have narrowed potential ingredients and developed a formulation for each component, which is described in more detail below.

In some embodiments, the foamed hydrogel of the present disclosure has an improved foaming ability with an increased mechanical strength, thereby holding onto a target, which is a plant, a crop, or an area where the plant or crop is growing. The present disclosure teaches that a 6 cm thick cylinder of the foamed hydrogel hold onto ¼ inch wood dowel placed 4 cm from a slick vinyl coated board set that is 70° from vertical, for about 30 minutes, about 20 minutes, about 10 minutes, or about 5 minutes without deforming, as describe in Example 1.

In some embodiments, the hydrogel comprising a polymer solution and a crosslinker solution, prior to being foamed, has a water content of about 80% to about 99% by weight, when gas porosity is less than 1%. In some embodiments, the foamed hydrogel, after being foamed by compressed gas, has a gas porosity of about 50% to about 99% by volume. In some embodiments, the foamed hydrogel has gas bubbles with an average diameter of about 0.1 mm to about 1 cm, about 0.1 mm to about 2 cm, about 0.1 mm to about 3 cm, about 0.1 mm to about 4 cm, about 0.1 mm to about 5 cm, about 0.1 mm to about 6 cm, about 0.1 mm to about 7 cm, about 0.1 mm to about 8 cm, about 0.1 mm to about 9 cm, or about 0.1 mm to about 10 cm.

In some embodiments, the crosslinker readily reacts with the polymer to form a covalent bond in ambient conditions from about −10° C. to about 40° C., 0° C. to about 40° C., 5° C. to about 40° C., 10° C. to about 40° C., 15° C. to about 40° C., 20° C. to about 40° C., or 25° C. to about 40° C., and relative humidity between about 10% to 100%. In some embodiments, the polymer and the crosslinker have a reaction half-life of 1 second to 600 seconds or 1 second to 500 seconds. In some embodiments, the polymer and the crosslinker have a reaction half-life of 600 seconds or less, 550 seconds or less, or 500 seconds or less.

In some embodiments, the hydrogel has a polymer concentration of about 1% to about 10% by weight, about 0.5% to about 5% by weight, about 0.1% to about 2% by weight, about 3.5% to about 10% by weight, about 2% to about 7.5% by weight, about 3.5% to about 15% by weight, about 3.5% to about 25% by weight.

In some embodiments, the hydrogel has a crosslinker concentration of about 1% to about 10% by weight, about 0.1% to about 1% by weight, about 0.1% to about 3.5% by weight, about 0.1% to about 5% by weight, about 1% to about 5% by weight, or about 1% to about 15% by weight, when gas porosity is less than 1%.

### Polymer

Hydrogels are networks of hydrophilic polymer chains that swell and retain large amounts of water while maintaining their mechanical structure. By definition hydrogels contain a minimum of about 10% water by weight. The hydrophilicity of hydrogel is due to the high density of hydrophilic functional groups such as —NH₂, —COOH, —OH, —CONH₂ and SO₃H on the polymer peptides. The concentration of polymer in solution to achieve a stable hydrogel can vary greatly depending on each polymer's hydrophilicity (i.e., swelling degree) and the properties of the solution (e.g., pH, ionic strength, temperature), from less than about 1% up to about 90% by weight.

Hydrogel polymers can be divided into two groups, synthetic and natural. Synthetic polymers are derived from petroleum products, including for example polyethylene glycol (PEG) and polyacrylic acid (PAA). There is an extensive and broad range of synthetic polymers with variations in polymer morphology, constituent monomers and functional groups, monomer and functional group arrangement, and polymer length, which allow for a very broad range of properties. In most cases however, synthetic polymers have poor or no biodegradability, limiting their use as an agricultural applicant to only low concentrations due to potential accumulation issues in soil. The notable exception is polyvinyl alcohol which has been shown to have moderate biodegradability in field conditions, including by Suzuki et al (1973).

Natural polymers in contrast are derived from organic sources such as wood, algae or shellfish. Examples include carboxymethyl cellulose (CMC) typically derived from wood cellulose, and alginate which is derived from seaweed. Natural polymers are readily biodegradable, and functionalization of these polymers to improve their properties, such as functionalization cellulose with esters in the case of methyl cellulose, can improve polymer properties without significantly reducing biodegradability.

As a major component of the solution, and in certain cases the most important component after water, the polymers specifications are crucial to achieving the foams overall characteristics. In an embodiment of this disclosure, the polymer should meet several specifications. The polymer must be water-soluble, this includes polymers that have poor water-solubility as a single component in water, but can achieve about 50% about 55%, about 60%, about 65%, about 70%, about 75% or more water solubility when dissolved with a chemical additive that aids its dissolution, for example salt or an acid. The polymer must have a sufficiently low viscosity to allow the solution to be foamed, this is ideally a viscosity below 300 centipoises (cP) at concentration of about 5% by weight in solution, a viscosity below 1000 centipoises (cP) at concentration of about 10% by weight in solution, a viscosity below 1200 centipoises (cP) at concentration of about 8% by weight in solution, a viscosity below 900 centipoises (cP) at concentration of about 9% by weight in solution, or a viscosity below 150 centipoises (cP) at concentration of about 1% by weight in solution. In some embodiments, the polymer is biodegradable, enabling its widespread use on agricultural land. In further embodiments, a foamed hydrogel of the present disclosure, comprising a polymer and a crosslinker, is also biodegradable.

The crosslinking of the polymer depends on the available polymer functional groups. In an embodiment of this disclosure, the polymer will have at high density of one, or a combination of the following functional groups; —NH₂, —COOH, —OH, —CONH₂, or SO₃H. In further embodiments, a functional group of the polymer is —NH₂, —COOH, or —OH.

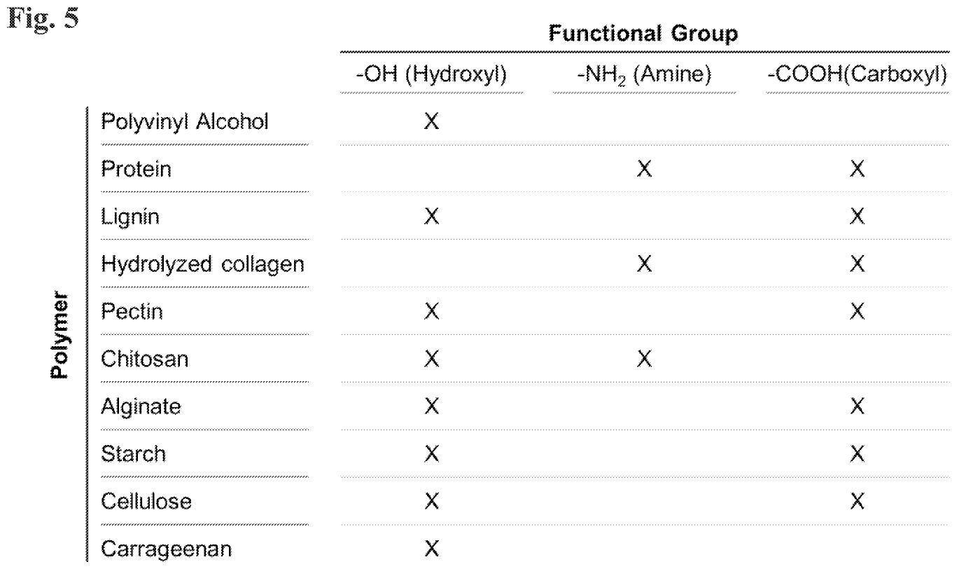

Several potential polymers meet these specifications and are detailed in FIG. 5, these include: polyvinyl alcohol, proteins including soy protein and whey protein, lignin, —including oxidized versions of lignin such as oxidized kraft lignin and oxidized lignosulphonate, pectin, denatured collagen, chitosan, alginate, carrageenan, starch and cellulose, including the esters and ethers of both starch and cellulose.

Certain embodiments of this disclosure have a blend of polymers, whose combined properties may offer advantages.

### Chemical Crosslinker

In order to achieve rapid gelation of the hydrogel foam, the chemical crosslinker must have rapid reaction kinetics with the polymer in solution to form a covalent bond. In order to enable rapid and effective foam generation, deposition onto the crop and gelation, the crosslinking reaction must be sufficiently rapid to induce a sufficient increase in mechanical strength of the foam within 600 seconds. In some embodiments, the crosslinker and polymer react to induce a sufficient increase in mechanical strength of the foam within 1 hour, within 30 minutes, within 25 minutes, within 20 minutes, within 15 minutes, within 10 minutes, within 9 minutes, within 8 minutes, within 7 minutes, within 6 minutes, within 5 minutes, within 4 minutes, within 3 minutes, within 2 minutes, within 1 minute, within 60 seconds, within 55 seconds, within 50 seconds, within 45 seconds, within 40 seconds, within 35 seconds, within 30 seconds, within 25 seconds, within 20 seconds, within 15 seconds, within 10 seconds, within 9 seconds, within 8 seconds, within 7 seconds, within 6 seconds, within 5 seconds, within 4 seconds, within 3 seconds, within 2 seconds, or within 1 second.

Crosslinker toxicity is another constraint, both for the health and safety of operators working with and applying the product in field, and for the health of the plant. In some embodiments, the crosslinker toxicity is neutralized by the polymer or another additive in solution during the crosslinking process rendering it safe and benign.

As a crosslinker is defined by its functional group and the reactive group rather than the specific particle, functional groups and reactive group pairs are provided herewith. In an embodiment of this disclosure, crosslinkers form hydrogels with the following functional pairs that meet the specifications mentioned above, aldehyde-amine reactions, carboxyl-carbodiimide reactions, divalent metal-hydroxyl bonds, trivalent metal-hydroxyl bond. Aldehyde-amine reactions include for example glutaraldehyde (GTA) and chitosan, or glutaraldehyde and denatured collagen. Carboxyl-carbodiimide reactions include for example 1-Ethyl-3-(3-dimethylaminopropyl) carbodiimide and denatured collagen. Divalent metal-hydroxyl reactions include for example Ca²⁺ and sodium alginate. Trivalent metal-hydroxyl reactions include for example Fe³⁺ and sodium alginate.

In some embodiments, the crosslinker is a chemical crosslinker. In some embodiments, a functional group of the crosslinker is aldehyde or carbodiimide. In some embodiments, the aldehyde functional compound comprises glutaraldehyde (GTA) or glyoxal. In some embodiments, the carbodiimide functional compound comprises 1-Ethyl-3-(3-dimethylaminopropyl) carbodiimide.

In other embodiments, the crosslinker is a physical crosslinker. In other embodiments, a functional group of the crosslinker is divalent metal selected from the group consisting of Ca²⁺, Mg²⁺, Zn²⁺, Sr²⁺, Ba²⁺, Cu²⁺, and Fe²⁺, or trivalent metal selected from the group consisting of Fe³⁺, Cr³⁺, and Al³⁺. In some embodiments, the Ca²⁺ is calcium carbonate or calcium chloride, and the Fe³⁺ is ferric iron chloride or ferric iron sulphate.

### Surfactant

Foaming requires a surface-active agent to stabilize the air-water interface between the bubble and the surrounding solution. This may either be achieved by the surface-active properties of the polymer in solution, for instance polyvinyl alcohol, or by the addition of a surfactant to solution. A challenge for the disclosed technology is to limit the risk of the surfactant reacting with the crosslinker in solution, as this will needlessly consume the crosslinkers reactive functional group and reduce the overall foam strength, thus weaking the mechanical strength of the foam. In some embodiments, the surfactant is biodegradable and non-toxic. Potential surfactants include sodium lauryl sulphate (SLS), sodium laureth sulphate (SLES), cocoamidopropyl betaine (CAPB), coco betaine, triton-X, tween-20, and tween-80.

Method of Protecting a Plant from Environmental Stressors

The present disclosure provides a method of protecting a plant from an abiotic stressor, comprising: applying the hydrogel composition taught herein to the plant or area in which the plant is growing. In some embodiments, the abiotic stressor is at least one selected from the group consisting of smoke, sun exposure, and frost.

The present disclosure provides a method of protecting a plant from a biotic stressor, comprising: applying the hydrogel composition taught herein to the plant or area in which the plant is growing. In some embodiments, the biotic stressor is at least one selected from the group consisting of a fungus, a bacterium, a pathogen, an insect, and a pest.

The present disclosure provides a method of protecting a plant from an abiotic or biotic environmental stressor, comprising: applying to a plant, or area where a plant is growing, a hydrogel composition comprising: (a) a polymer solution (b) a crosslinker solution.

### Method of Generating a Foamed Hydrogel

The present disclosure provides a method of generating a foamed hydrogel, comprising: (a) providing a polymer solution comprising water and a polymer; (b) providing a crosslinking solution comprising water and a crosslinking agent; and (c) mixing the polymer solution, the crosslinking solution, and a gas to form a foamed mixture. In some embodiments, step (c) is performed by (i) mixing the polymer solution with a compressed gas and (ii) mixing the compressed gas-polymer solution with the crosslinking solution. In other embodiments, step (c) is performed by (i) mixing the polymer solution with the crosslinking solution; and (ii) mixing the polymer-crosslinker solution with compressed gas. In further embodiments, step (c) is performed by (i) mixing the crosslinker solution with a compressed gas; and (ii) mixing the compressed gas-crosslinker solution with the polymer solution. In some embodiments, the mixture is applied to a portion of a plant within 800 seconds, within 700 seconds, within 600 seconds, within 500 seconds, or within 400 seconds, after the polymer solution and the crosslinker solution are mixed to form the foamed mixture.

The present disclosure provides a method of preparing a polymer solution concentrate, comprising: (a) blending water and a polymer and (b) containing the solution in a resistant package that is transport and storage resistant.

The present disclosure provides a method of preparing a crosslinker solution concentrate, comprising: (a) blending water and a crosslinker and (b) containing the solution in a resistant package that is transport and storage resistant.

### EXAMPLES

### Example 1: Strength and Crosslinking Time of Chitosan and Glutaraldehyde Foamed Hydrogel

### Step 1

At ambient conditions between 20° C. and 25° C., a polymer solution and a crosslinker solution were prepared with the following compositions in 500 ml containers that had been cleaned 3 times with water. Using a balance to measure out each component, the polymer solution was composed of 1% of chitosan, 0.5% glacial acetic acid, 0.3% sodium laureth sulphate and 0.1% of myristic acid, in distilled water for a total mass of 300 g. In order to minimize clumping of the chitosan and ensure proper homogenization, a chitosan solution was prepared first at 2% by weight in 1% acetic acid. The solution was then mixed 1:1 with water containing 0.6% sodium laureth sulphate and 0.2% myristic acid and stirred at 300 rpm using a magnetic stir bar. The solution was then allowed to blend for 30 minutes to ensure it was homogenized.

The crosslinker solution was composed a prescribed amount of 25% glutaraldehyde to achieve target crosslinker concentrations for evaluation.

### Step 2

Using a bench-top blender, specifically a KitchenAid Professional 600 Series 6 stand mixer, the polymer solution was mixed at the maximum speed setting, about 200 rpm, using the whisk whip for 5 minutes to ensure maximum and homogeneous foaming. The whisking entrained air into the solution leading to the aeration of the solution.

### Step 3

Once the polymer solution was foamed, the crosslinking solution was added with the stand mixer at maximum speed and blended for 30 seconds. The stand mixer was then turned off and the whisk removed.

### Step 4

Using a plastic syringe with a cut end and an inner diameter of 6 cm, such that the syringe can pull and extrude 6 cm cylinders of foam, 500 ml of foam is suctioned into the syringe.

### Step 5

To test the mechanical strength of the foam, and its ability to hold onto a crop, a rig was designed to test each formulation's ability to hold onto a ¼ inch branch. Briefly, a vinyl coated piece of particle board was screwed to a base plate with an angle of 70° from vertical. A ¼ inch thick wooden dowel was then affixed horizontally using spacers, at a distance of 4 cm from the particle board from its center.

The foam was then extruded into 3-5 cm thick cylindrical wedges with a diameter of 6 cm, onto the foam strength testing rig at set time intervals to test the strength of the foam after different crosslinking times. The foam was placed onto the ¼ inch wooden dowel and was leaning against the particle board. The foam was then monitored for 30 minutes to observe whether it would hold in place or begin to deform. The foam was placed onto the rig at the following time intervals after collection from the stand mixer: 10 seconds, 30 seconds, 60 seconds.

### Step 6

The test was repeated, varying both the chitosan concentration and the glutaraldehyde concentration to test crosslinking time and impact on foam strength. For a 1% chitosan concentration, the trial was repeated with the following glutaraldehyde (GTA) concentrations: 0%, 0.1%, 0.2%, 0.3%, 0.5%, and 1%. At a set concentration of 0.3% glutaraldehyde, the trial was repeated with the following chitosan concentrations: 0.25%, 0.5%, 1%, 1.5%.

The test was also repeated for denatured collagen and glutaraldehyde. For a 0.3% GTA concentration, tests were completed at 2% and 4% concentration denatured collagen. In step 1, acetic acid was not included when completing tests with denatured collagen, and the temperature was maintained several degrees above ambient to improve polymer solubility.

All glutaraldehyde, denatured collagen and chitosan concentrations above are in weight percent.

### Results

This trial was meant to demonstrate that a polymer and crosslinker solution could be combined to form a stable foamed hydrogel with the strength to hold onto a simulated branch. For the sake of simplicity, the trial was completed using a stand mixer, which allows for faster and reproducible sample preparation. An example with a continuous flow foaming device, as described in an embodiment of this disclosure, is detailed in example 4.

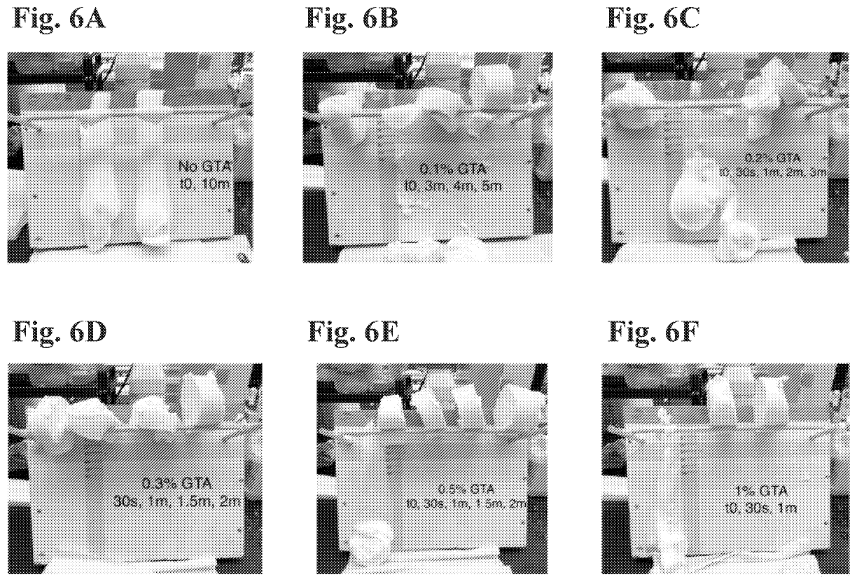

For the first set of experiments, where chitosan concentrations were maintained at 1% while glutaraldehyde concentration was varied, there is a clear shortening in the time required to create a stable foamed hydrogel that could hold on the rig and not deform. Results are displayed in FIGS. 6A-6F, starting from a sample with not added glutaraldehyde (FIG. 6A), which did not hold, the 0.1% GTA solution took 5 minutes to form a sufficiently strong foamed hydrogel (FIG. 6B). This decreases to 3 minutes for a 0.2% GTA foam (FIG. 6C), 2 minutes for a 0.3% GTA foam (FIG. 6D), 1 minute for a 0.5% GTA foam (FIG. 6E) and finally 30 seconds for a 1% GTA foam (FIG. 6F).

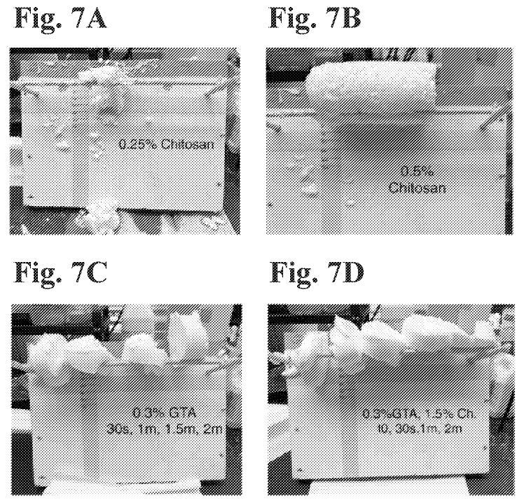

In the second set of trials, results can be viewed in FIGS. 7A-7D, GTA was kept constant at 0.3%, 0.25% chitosan did not hold (FIG. 7A), 0.5% chitosan took 10 minutes to form a sufficiently stable foam (FIG. 7B), 1% chitosan took 2 minutes (FIG. 7C), which 1.5% chitosan took 1 minute (FIG. 7D). The foams tested this example were held in place for 30 minutes.

In the last set of trials, the denatured collagen formed a stable foam at 4%, but did not form a stable foam at 2% concentration within the 600 second window, suggesting the boundary for 0.3% GTA was between 2-4% hydrolyzed protein.

These trials demonstrate that a crosslinker and biodegradable polymer can be foamed and combined to form a mechanical stiff foamed hydrogel, and that concentration can be used to manage the reaction kinetics to achieve the ideal crosslinking timing.

### Example 2: Method of Generating a Foamed Hydrogel to Protect a Branch from Frost

### Step 1

At ambient conditions between 15° C. and 25° C., a polymer solution and a crosslinker solution were prepared with the following compositions in 500 ml containers that had been cleaned 3 times with water.

Using a balance to measure out each component, the polymer solution was composed of 1% of chitosan, 0.5% glacial acetic acid, 0.3% sodium laureth sulphate and 0.1% of myristic acid, in distilled water for a total mass of 300 g. In order to minimize clumping of the chitosan and ensure proper homogenization, a chitosan solution was prepared first at 2% by weight in 1% acetic acid. The solution was then mixed 1:1 with water containing 0.6% sodium laureth sulphate and 0.2% myristic acid and stirred at 300 rpm using a magnetic stir bar. The solution was then allowed to blend for 30 minutes to ensure it was homogenized.

The crosslinker solution was composed 6 g of 25% glutaraldehyde.

### Step 2

Using a bench-top blender, specifically a KitchenAid Professional 600 Series 6 stand mixer, the polymer solution was mixed at the maximum speed setting, ~200 rpm, using the whisk whip for 5 minutes to ensure maximum and homogeneous foaming. The whisking entrained air into the solution leading to the aeration of the solution.

### Step 3

Once the polymer solution was foamed, the crosslinking solution was added with the stand mixer at maximum speed and blended for 30 seconds. The stand mixer was then turned off and the whisk removed. Using a plastic syringe with a cut end and an inner diameter of 6 cm, such that the syringe can pull and extrude 6 cm cylinders of foam, 500 ml of foam was suctioned into the syringe.

### Step 4

The foam was left to crosslink completely for 10 minutes in the cylinder and was then extruded onto a plastic plate to form a 10 cm long cylinder with a 6 cm diameter. Steps 1 through 4 were then repeated to generate a duplicate cylinder. Metal temperature probes were then inserted into the center of the foam cylinders to measure the internal temperature.

### Step 6

The foam cylinders were placed in a freeze chamber and the freezer was set to 5° C. for 2 hours, and then the freezer was set to −3° C. and was then progressively decreased towards −7° C. over 4 hours.

### Results

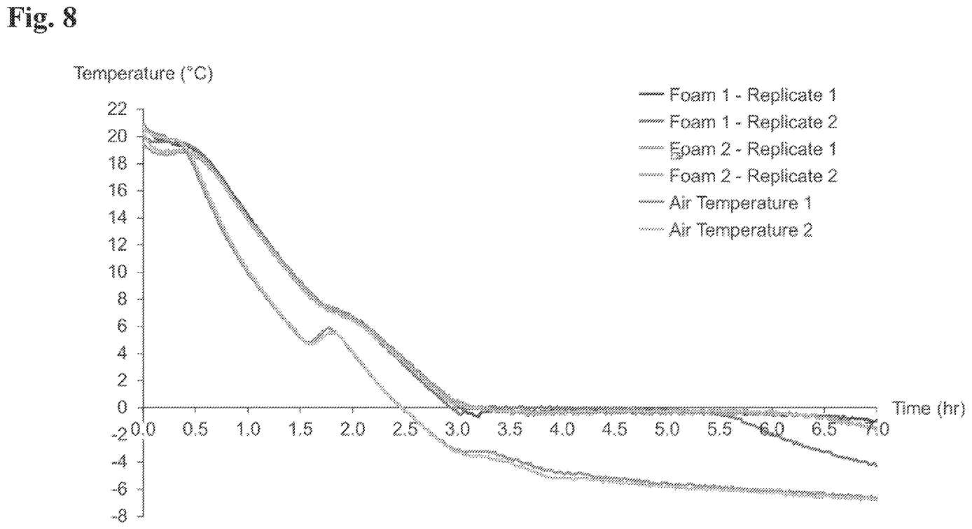

The tests results, which can be seen in FIG. 8, show that the center of the foam was kept above −0.7° C., which is above the typical damage point of −1° C. or lower, for 3-4 hours total.

### Example 3: Hydrogel Crosslinking Time of Different Crosslinker and Polymer Combinations

### Step 1

At ambient conditions between 15° C. and 25° C., a polymer solution and a crosslinker solution were prepared using a clean 15 ml clear plastic centrifuge tube. Using a scale to measure out each component, a polymer solution was composed of 0.5 g of denatured collagen in 3.5 g of water. The centrifuge tube was place in a water bath held at a temperature several degrees above ambient and periodically mixed to fully homogenize the polymer over the course of an hour.

Using a glass beaker, 0.2 g of 25% glutaraldehyde was mixed with 0.8 g water to form the crosslinker solution. Using a pipette, the crosslinker solution was pipette into the 15 ml centrifuge tube holding the polymer solution and mixed vigorously for 5 seconds using a vortex mixer.

### Step 2

The solution was inverted every 30 seconds and visually assessed for solution viscosity and returned to the water bath between flips. Once the solution was thick enough such that it would no longer flow, and would instead form a solid mass or a highly viscous fluid, the time was noted.

### Step 3

Steps 1-2 were repeated, changing the crosslinker and polymer combination and concentration to determine combinations that would crosslink within 10 minutes. Combinations included denatured collagen and 1-Ethyl-3-(3-dimethylaminopropyl) carbodiimide (EDC), chitosan and glutaraldehyde, sodium alginate and CaCl₂), sodium alginate and Fe(III)Cl₃, sodium alginate and CuCl₂.

### Results

The results showed that denatured collagen will crosslink and generate a sufficient increase in viscosity with both 1-Ethyl-3-(3-dimethylaminopropyl) carbodiimide and glutaraldehyde within the 600 second time window. Additionally, chitosan exhibited a sufficient increase in viscosity with glutaraldehyde within the 600 second time window.

For a glutaraldehyde concentration of 0.3%, the minimum concentration of denatured collagen was around 4%, and the minimum chitosan concentration was 0.5%. For 1-Ethyl-3-(3-dimethylaminopropyl) carbodiimide concentration of 1.5%, the minimum denatured collagen concentration was 10%. Most importantly, 1-Ethyl-3-(3-dimethylaminopropyl) carbodiimide and glutaraldehyde showed variability in the reacting time with different concentrations of crosslinker and/or polymer solution. For sodium alginate, across all three tested ions, the crosslink occurred within 3 seconds, leading to a solid gel for all samples with concentration above 1% for the ion, and 2% alginate.

### Example 4: Method of Generating a Continuously Foamed Chitosan Hydrogel

### Step 1

At ambient conditions between 15° C. and 25° C., a polymer solution and a crosslinker solution were prepared with the following compositions in 500 ml containers that had been cleaned 3 times with water. Using a balance to measure out each component, the polymer solution was composed of 1% of chitosan, 0.5% glacial acetic acid, 0.3% sodium laureth sulphate and 0.1% of myristic acid, in distilled water for a total mass of 200 g. In order to minimize clumping of the chitosan and ensure proper homogenization, a chitosan solution was prepared first at 2% by weight in 1% acetic acid. The solution was then mixed 1:1 with water containing 0.6% sodium laureth sulphate and 0.2% myristic acid and stirred at 300 rpm using a magnetic stir bar. The solution was then allowed to blend for 30 minutes to ensure it was homogenized.

The crosslinker solution was composed 4.0 g of 25% glutaraldehyde and 116.4 g of water.

### Step 2

Using a compressed-air-foaming (CAF) device, the polymer and crosslinking solution were mixed at pump through a diffuser at 200 mL/min. The solution is homogenized through turbulent mixing and is then injected with compressed air at a rate of 1.35 liters/min at a pressure of 30 psi, before being sent through a series of screens in the CAF device to achieve a well-mixed foam. The mixing chamber and CAF screens have a residence time of below 10 seconds.

### Step 3

As the foam exits the CAF device, it was deposited onto a flat tray and allowed to crosslink fully forming a 3 cm thick coat of foam and left to rest overnight.

### Results

Continuously forming chitosan hydrogel foams were successfully prepared using the CAF. When formed without crosslinkers, foams would collapse and lose structural features critical to insulative properties. Conversely, when crosslinked with GTA, chitosan foams prepared using a continuous, CAF method remained stable and unchanged for more than 24 hours.

### Example 5: Method of Generating Continuously Foamed Alginate Hydrogel

### Step 1

At ambient conditions between 15° C. and 25° C., a polymer solution and a crosslinker solution were prepared with the following compositions in 500 ml containers that had been cleaned 3 times with water. Using a balance to measure out each component, the polymer solution was composed of 0.5% of alginate, 0.3% sodium laureth sulphate and 0.1% of myristic acid, in distilled water for a total mass of 200 g. In order to minimize clumping of the alginate and ensure proper homogenization, an alginate solution was prepared first at 2% by weight in water. The solution was then mixed 1:3 with water containing 0.4% sodium laureth sulphate and 0.13% myristic acid and stirred at 300 rpm using a magnetic stir bar. The solution was then allowed to blend for 30 minutes to ensure it was homogenized.

A crosslinker solution was prepared using a 100 ml glass beaker that was cleaned 3 times with water. Using a balance to measure out each component, 99 g of water and 1 g of CaCl₂) were added into the beaker and placed on a stir-plate and allowed to mix using a magnetic stir bar rotating at 300 rpm for a total of 30 minutes to fully dissolve.

### Step 2

Using a compressed-air-foaming (CAF) device, the polymer solution is pumped into a mixing chamber at a rate of 150 ml/min and mixed with compressed air with a flow rate of 1.2-1.5 L/min at a pressure of 10-15 psi. The mixture is then passed through a series of filter screens in the CAF device to achieve a well-mixed foam.

### Step 3

At the exit of the CAF device, the crosslinker solution was injected and mixed into the polymer-air foam mixture at a rate of 10.5 ml/min and is then deposited onto a ¼ inch branch. In less than 2 seconds, the foam had hardened to form a foamed hydrogel. Several layers of foam were applied to the branch in order to coat the branch with 3 cm of foam on all sides and it held for several hours.

### Example 6: Method of Generating a Continuously Foamed Denatured Collagen Hydrogel

### Step 1

At ambient conditions between 15° C. and 25° C., a polymer solution and a crosslinker solution were prepared with the following compositions in 500 ml containers that had been cleaned 3 times with water. Using a balance to measure out each component, the polymer solution was composed of 10 g of denatured collagen, 1 g of 30% sodium laureth sulphate, 0.1 g of myristic acid, and 88.9 g of distilled water for a total mass of 100 g. In order to minimize clumping of the denatured collagen and ensure proper homogenization, denatured collagen was prepared at 15% prior to mixing with water containing sodium laureth sulfate and myristic acid. The solution was then stirred at 300 rpm using a magnetic stir bar and was warmed a few degrees above ambient to improve polymer dissolution. The solution was then allowed to blend for 30 minutes to ensure it was homogenized.

The crosslinker solution was composed 4.5 g of 1-Ethyl-3-(3-dimethylaminopropyl) carbodiimide, 13.5 g of n-hydroxysuccinimide and 102 g of water.

### Step 2

Using a compressed-air-foaming (CAF) device, the crosslinker and polymer solution were pumped at a continue rate of 150 ml/min at a ratio of 1.5:1.0 polymer to crosslinker into a mixing chamber. The mixed solution was then injected with compressed air at a rate of 1.1-1.5 liters/min at a pressure of 20-25 psi, before being sent through a series of screens in the CAF device to achieve a well-mixed foam. The mixing chamber and CAF screen filters have a residence time of below 10 seconds.

### Step 3

Upon exiting the CAF device the foam stiffened in less than 60 seconds and held when in place on a ¼ inch branch for more than 12 hours

### Example 7: April, Year 1 Frost in South-Western France and Resulting Impacts

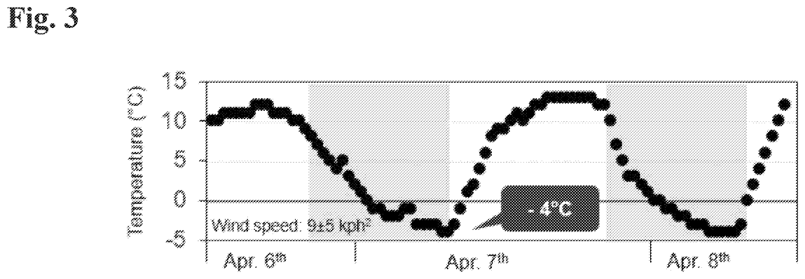

During the early morning hours of April 7^{th} and April 8^{th}, year 1 temperatures in the south-west of France fell from a daytime high of 12-13° C. to a low of −4° C. with temperature below 0° C. spanning from roughly 1 am to 9 am local time, as can be observed in FIG. 3. The frost was caused by a large cold front that came down from the north-Atlantic ocean and covered much of western Europe with unseasonably cold weather. The temperature in late March and early April had been until that point warm and reaching temperature well above 10° C., resulting in many early varieties of grape vine, and some tree fruit such as pears and cherries, to begin budding out. Early varieties of grapes had gone beyond bud-swell, and inventors are beginning to leaf out. With this advance budding stage, many crops would suffer significant damage from a frost temperate below −1° C.

French growers typically protect their crops from frost either by using wind-machines, in areas with strong radiation frosts where the ground temperature is lower than the air above it, wind turbines can protect crops by mixing the cold ground air with the air above it and raise the temperature of the air on the ground by 1-2° C. Another technique is to light fires to heat up the air and anything surrounding the fire. These may include hay or straw bales, propane burners and large wax candles, however due to increasing labor costs, most growers that use this technique now rely on wax candles as they're easier to manage and operate. Due to the nature of the frost there was a low temperature gradient, this meant that wind machines proved largely ineffective against the frost. Additionally, when initially forecast, the frost was forecast to last 2-3 days, given the long duration this would have required that growers protecting their crops with fires light and maintain the fires potentially for up to 3 continuous nights. Given the high cost of lighting fires, most growers using this technique was not a cost-effective proposition and would have cost more than the value of a potential crop assuming the crop was saved. Another technique which is often employed by growers in protection with irrigation, where water is continually irrigated onto crops and the release of heat during the freezing of the water maintains the temperature of the crop above the freezing point of the water. However, due to the dry conditions in the south-west of France, this technique is banned in most areas and irrigation-based protection is largely non-existent.

The result of this weather event was a roughly 25% reduction in wine volume for the Gironde region of south-west France, relative to the 15-year average for the area. Low-lying regions lost up to about 90% of their harvest, largely due to frost, while other areas are only lightly affected.

The challenge of this frost was two-fold, the multi-night duration meant that active frost fighting technologies such as fires rapidly became expensive due to the long operating times. Wind-machine based technologies were ineffective due to the type of frost. In this situation, hydrogel foam insulation-based protection could have been a viable alternative, such as is described in Example 2 and FIG. 8. Hydrogel foams offer protection to temperatures far below-4° C., and a single application will offer protection for several days.

### Example 8: Method of Protecting a Plant

### Step 1

Once the risk of a potential frost has been established, using available resources, such as weather forecasts, knowledge of the plant's location and local geography, and historical knowledge of how other frost events have occurred in this area, estimate the maximum potential temperature that could occur.

### Step 2

Using a compressed-air foaming device, apply the foam manufactured according to Example 4, 5 or 6, to the part of the plant that requires protection. Coat the plant with sufficient foam to protect against the maximum freezing temperature which has been estimated in step 1. For example, for a −7° C. frost, it may require 5 cm thick coating of foam, for a −2° C. it may only require a 3 cm thick coating of foam.

### Example 9: Method of Manufacturing Polymer Concentrates

### Step 1

To manufacture 100 kg polymer solution concentrate with a concentration factor of 2:1, select a 110-liter reinforced plastic container that is of appropriate quality for transport on rail and truck for long distances, and rinse it out with water to ensure that it is clean

### Step 2

In a separate container large enough to hold 110 liters of liquid, add 84.85 kg distilled water and mix in 1.1 kg of glacial glade 99% acetic acid and mix by hand with a cleaned stirring instrument. It is not necessary to blend the solution in a separate container and blending can be completed in the transport container, however it is often easier to blend in a separate container and then pour the final product into the container for transport.

### Step 3

Mix into the container the remaining ingredients, 11.2 kg of Chitosan, 2.467 kg of 30% Sodium Laureth Sulphate, 0.38 kg Cocamidopropyl Betaine.

### Step 4

Pour the blended concentrate solution into the plastic container for transport and seal the container.

### Example 10: Method of Manufacturing a Crosslinking Solution Concentrate

### Step 1

To manufacture 100 kg crosslinker solution concentrate with a concentration factor of 2:1, select a 110-liter reinforced plastic container that is of appropriate quality for transport on rail and truck for long distances, and rinse it out with water to ensure that it is clean

### Step 2

In a separate container large enough to hold 110 liters of liquid, 80 kg of distilled water and blend in 20 kg of pure glutaraldehyde, mix the solution by hand using a clean stirring instrument.

It is not necessary to blend the solution in a separate container and blending can be completed in the transport container, however it is often easier to blend in a separate container and then pour the final product into the container for transport.

### Step 3

Pour the blended concentrate solution into the plastic container for transport and seal the container.

### Example 11: Method of Diluting Concentrate for Use on Farm

### Step 1

To dilute a polymer or crosslinker solution to the correct concentration, a machine operator first determines the level of dilution necessary on the packaging. For this example, inventors assume a 50% concentrate. To form a 200 kg solution of polymer, the operator first fills the solution tank of his compressed-air-foam (CAF) spraying machine with 100 kg of water using a measuring system on the machine, ideally a measuring stick or probe.

### Step 2

Once 100 kg of water have been added to the CAF machine, the operator will pour 100 kg of polymer concentrate into the tank. The operator will then mix the solution to ensure homogeneity, either by hand mixing with a stirring instrument, or using a stirring device that is installed in the solution tank of the CAF for this purpose.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto; inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

### INCORPORATION BY REFERENCE

All references, articles, publications, patents, patent publications, and patent applications cited herein are incorporated by reference in their entireties for all purposes. However, mention of any reference, article, publication, patent, patent publication, and patent application cited herein is not, and should not be taken as an acknowledgment or any form of suggestion that they constitute valid prior art or form part of the common general knowledge in any country in the world.
Tomoo Suzuki, Yoshihiro Ichihara, Masaru Yamada, Kenzo Tonomura, Some Characteristics of Pseudomonas 0-3 which Utilizes Polyvinyl Alcohol, Agricultural and Biological Chemistry, Volume 37, Issue 4, 1 Apr. 1973, Pages 747-756

### NUMBERED EMBODIMENTS OF THE DISCLOSURE

Subject matter contemplated by the present disclosure is set out in the following numbered embodiments:
1. A foamed hydrogel composition, comprising:
   a. a polymer;
   b. a crosslinker; and
   c. compressed gas capable of foaming a hydrogel into a foamed hydrogel.
2. The foamed hydrogel composition of embodiment 1, wherein a functional group of the polymer is selected from the group consisting of —NH₂, —COOH, and —OH.
3. The foamed hydrogel composition of embodiment 1, wherein the polymer is a naturally derived polymer.
4. The foamed hydrogel composition of embodiment 1 or 3, wherein the polymer is selected from the group consisting of protein, lignin, denatured collagen, chitosan, starch, alginate, pectin, carrageenan, and cellulose.
5. The foamed hydrogel composition of embodiment 4, wherein the lignin comprises oxidized derivatives of lignin.
6. The foamed hydrogel composition of embodiment 4, wherein the lignin comprises kraft lignin, alkali lignin, or lignosulphonate.
7. The foamed hydrogel composition of embodiment 4, wherein the protein comprises soy protein, whey protein, hydrolyzed derivates of soy protein, or hydrolyzed derivates of whey protein.
8. The foamed hydrogel composition of embodiment 4, wherein the carrageenan comprises kappa carrageenan, iota carrageenan, or lambda carrageenan.
9. The foamed hydrogel composition of embodiment 4, wherein the cellulose comprises ester and, or ether derivates.
10. The foamed hydrogel composition of embodiment 9, wherein the ether derivatives of the cellulose comprises carboxymethyl cellulose, hydroxypropyl methyl cellulose, methyl cellulose, or hydroxyethyl cellulose.
11. The foamed hydrogel composition of embodiment 1, wherein the polymer is a synthetically derived polymer.
12. The foamed hydrogel composition of embodiment 1 or 11, wherein the polymer is polyvinyl alcohol.
13. The foamed hydrogel composition of embodiment 1, wherein the crosslinker is a chemical crosslinker.
14. The foamed hydrogel composition of embodiment 1 or 13, wherein a functional group of the crosslinker is aldehyde or carbodiimide.
15. The foamed hydrogel composition of embodiment 14, wherein the aldehyde comprises glutaraldehyde or glyoxal.
16. The foamed hydrogel composition of embodiment 14, wherein the carbodiimide comprises 1-Ethyl-3-(3-dimethylaminopropyl) carbodiimide.
17. The foamed hydrogel composition of embodiment 1, wherein the crosslinker is a physical crosslinker.
18. The foamed hydrogel composition of embodiment 1 or 17, wherein a functional group of the crosslinker is divalent metal or trivalent metal.
19. The foamed hydrogel composition of embodiment 18, wherein the divalent metal is selected from the group consisting of Ca²⁺, Mg²⁺, Zn²⁺, Sr²⁺, Ba²⁺, Cu²⁺, and Fe²⁺.
20. The foamed hydrogel composition of embodiment 18, wherein the trivalent metal is selected from the group consisting of Fe³⁺, Cr³⁺, and Al³⁺.
21. The foamed hydrogel composition of embodiment 19, wherein the Ca²⁺ is calcium carbonate or calcium chloride.
22. The foamed hydrogel composition of embodiment 20, wherein the Fe³⁺ is ferric iron chloride or ferric iron sulphate.
23. The foamed hydrogel composition of any one of embodiments 1-22, wherein the polymer is biodegradable.
24. The foamed hydrogel composition of any one of embodiments 1-23, wherein the foamed hydrogel is biodegradable.
25. The foamed hydrogel composition of any one of embodiments 1-24, wherein the foamed hydrogel has an improved foaming ability with an increased mechanical strength, thereby holding onto a target.
26. The foamed hydrogel composition of embodiment 25, wherein the target is a plant, a crop, or an area in which the plant or crop is growing.
27. The foamed hydrogel composition of any one of embodiments 1-26, wherein a 6 cm thick cylinder of the foamed hydrogel hold onto ¼ inch wood dowel placed 4 cm from a slick vinyl coated board set that is 70° from vertical, for about 30 minutes without deforming significantly.
28. The foamed hydrogel composition of embodiment 1, wherein the hydrogel has a water content of about 80% to about 99% by weight, when gas porosity is less than 1% by volume.
29. The foamed hydrogel composition of embodiment 1, wherein the foamed hydrogel has a gas porosity of about 50% to about 99% by volume.
30. The foamed hydrogel composition of embodiment 1, wherein the foamed hydrogel has gas bubbles with an average diameter of about 0.1 mm to about 5 cm.
31. The foamed hydrogel composition of embodiment 1, wherein the crosslinker reacts with the polymer to form a covalent bond in ambient conditions from about −10° C. to about 40° C. and relative humidity between about 10% to 100%.
32. The foamed hydrogel composition of embodiment 1, wherein the polymer and the crosslinker have a reaction half-life of 1 second to 600 seconds.
33. The foamed hydrogel composition of embodiment 1, wherein the hydrogel has a polymer concentration of about 1% to about 10% by weight, when gas porosity is less than 1%.
34. The foamed hydrogel composition of embodiment 1, wherein the hydrogel has a polymer concentration of about 0.5% to about 5% by weight, when gas porosity is less than 1%.
35. The foamed hydrogel composition of embodiment 1, wherein the hydrogel has a polymer concentration of about 0.1% to about 2% by weight, when gas porosity is less than 1%.
36. The foamed hydrogel composition of embodiment 1, wherein the hydrogel has a polymer concentration of about 3.5% to about 10% by weight, when gas porosity is less than 1%.
37. The foamed hydrogel composition of embodiment 1, wherein the hydrogel has a polymer concentration of about 2% to about 7.5% by weight, when gas porosity is less than 1%.
38. The foamed hydrogel composition of embodiment 1, wherein the hydrogel has a polymer concentration of about 3.5% to about 15% by weight, when gas porosity is less than 1%.
39. The foamed hydrogel composition of embodiment 1, wherein the hydrogel has a polymer concentration of about 3.5% to about 25% by weight, when gas porosity is less than 1%.
40. The foamed hydrogel composition of embodiment 1, wherein the hydrogel has a crosslinker concentration of about 1% to about 10% by weight, when gas porosity is less than 1%.
41. The foamed hydrogel composition of embodiment 1, wherein the hydrogel has a crosslinker concentration of about 0.1% to about 1% by weight, when gas porosity is less than 1%.
42. The foamed hydrogel composition of embodiment 1, wherein the hydrogel has a crosslinker concentration of about 0.1% to about 3.5% by weight, when gas porosity is less than 1%.
43. The foamed hydrogel composition of embodiment 1, wherein the hydrogel has a crosslinker concentration of about 0.1% to about 5% by weight, when gas porosity is less than 1%.
44. The foamed hydrogel composition of embodiment 1, wherein the hydrogel has a crosslinker concentration of about 1% to about 5% by weight, when gas porosity is less than 1%.
45. The foamed hydrogel composition of embodiment 1, wherein the hydrogel has a crosslinker concentration of about 1% to about 15% by weight, when gas porosity is less than 1%.
46. A method of protecting a plant from an abiotic stressor, comprising: applying the foamed hydrogel composition of embodiment 1 to a plant or an area in which the plant or crop is growing.
47. The method of embodiment 46, wherein the abiotic stressor is smoke, sun exposure, or frost.
48. A method of protecting a plant from a biotic stressor, comprising: applying the foamed hydrogel composition of embodiment 1 to a plant or an area in which the plant is growing.
49. The method of embodiment 48, wherein the biotic stressor is a fungus, a bacterium, a pathogen, an insect, or a pest.
50. A method of generating a foamed hydrogel, comprising the steps of:
   a. providing a polymer solution comprising water and a polymer;
   b. providing a crosslinking solution comprising water and a crosslinking agent; and
   c. mixing the polymer solution, the crosslinking solution, and a gas to form a foamed hydrogel.
51. The method of embodiment 50, wherein step (c) is performed as follows:
   (i) mixing the polymer solution with a compressed gas; and
   (ii) mixing the compressed gas-polymer solution with the crosslinking solution.
52. The method of embodiment 50, wherein step (c) is performed as follows:
   (i) mixing the polymer solution with the crosslinking solution; and
   (ii) mixing the polymer-crosslinker solution with compressed gas.
53. The method of embodiment 50, wherein step (c) is performed as follows:
   (i) mixing the crosslinker solution with a compressed gas; and
   (ii) mixing the compressed gas-crosslinker solution with the polymer solution.
54. The method of embodiment 50, wherein the foamed hydrogel is applied to a target within 500 seconds after step (c) is done.
55. The method of embodiment 50, wherein the target is a plant, a crop, or an area in which the plant or crop is growing.
56. The method of embodiment 50, wherein a functional group of the polymer is selected from the group consisting of —NH₂, —COOH, and —OH.
57. The method of embodiment 50, wherein the polymer is a naturally derived polymer.
58. The method of embodiment 50 or 57, wherein the polymer is selected from the group consisting of protein, lignin, denatured collagen, chitosan, starch, alginate, pectin, carrageenan, and cellulose.
59. The method of embodiment 58, wherein the lignin comprises oxidized derivatives of lignin.
60. The method of embodiment 58, wherein the lignin comprises kraft lignin, alkali lignin, or lignosulphonate.
61. The method of embodiment 58, wherein the protein comprises soy protein, whey protein, hydrolyzed derivates of soy protein, or hydrolyzed derivates of whey protein.
62. The method of embodiment 58, wherein the carrageenan comprises kappa carrageenan, iota carrageenan, or lambda carrageenan.
63. The method of embodiment 58, wherein the cellulose comprises ester and, or ether derivates.
64. The method of embodiment 63, wherein the ether derivatives of the cellulose comprises carboxymethyl cellulose, hydroxypropyl methyl cellulose, methyl cellulose, or hydroxyethyl cellulose.
65. The method of embodiment 50, wherein the polymer is a synthetically derived polymer. 66. The method of embodiment 50 or 65, wherein the polymer is polyvinyl alcohol.
67. The method of embodiment 50, wherein the crosslinker is a chemical crosslinker.
68. The method of embodiment 50 or 67, wherein a functional group of the crosslinker is aldehyde or carbodiimide.
69. The method of embodiment 68, wherein the aldehyde comprises glutaraldehyde or glyoxal.
70. The method of embodiment 68, wherein the carbodiimide comprises 1-Ethyl-3-(3-dimethylaminopropyl) carbodiimide.
71. The method of embodiment 50, wherein the crosslinker is a physical crosslinker.
72. The method of embodiment 50 or 71, wherein a functional group of the crosslinker is divalent metal or trivalent metal.
73. The method of embodiment 72, wherein the divalent metal is selected from the group consisting of Ca²⁺, Mg²⁺, Zn²⁺, Sr²⁺, Ba²⁺, Cu²⁺, and Fe²⁺.
74. The method of embodiment ⁷², wherein the trivalent metal is selected from the group consisting of Fe³⁺, Cr³⁺, and Al³⁺.
75. The method of embodiment 73, wherein the Ca²⁺ is calcium carbonate or calcium chloride.
76. The method of embodiment 74, wherein the Fe³⁺ is ferric iron chloride or ferric iron sulphate.
77. The method of any one of embodiments 50-76, wherein the polymer is biodegradable.
78. The method of any one of embodiments 50-77, wherein the foamed hydrogel is biodegradable.
79. The method of any one of embodiments 50-78, wherein the foamed hydrogel has an improved foaming ability with an increased mechanical strength, thereby holding onto a plant or an area in which the plant is growing.
80. A method of preparing a polymer solution concentrate, comprising the steps of:
   a. blending water and a polymer; and
   b. containing the solution in a resistant package that is transport and storage resistant.
81. The method of embodiment 80, wherein a functional group of the polymer is selected from the group consisting of —NH₂, —COOH, and —OH.
82. The method of embodiment 80, wherein the polymer is a naturally derived polymer.
83. The method of embodiment 80 or 82, wherein the polymer is selected from the group consisting of protein, lignin, denatured collagen, chitosan, starch, alginate, pectin, carrageenan, and cellulose.
84. The method of embodiment 83, wherein the lignin comprises oxidized derivatives of lignin.
85. The method of embodiment 83, wherein the lignin comprises kraft lignin, alkali lignin, or lignosulphonate.
86. The method of embodiment 83, wherein the protein comprises soy protein, whey protein, hydrolyzed derivates of soy protein, or hydrolyzed derivates of whey protein.
87. The method of embodiment 83, wherein the carrageenan comprises kappa carrageenan, iota carrageenan, or lambda carrageenan.
88. The method of embodiment 83, wherein the cellulose comprises ester and, or ether derivates.
89. The method of embodiment 88, wherein the ether derivatives of the cellulose comprises carboxymethyl cellulose, hydroxypropyl methyl cellulose, methyl cellulose, or hydroxyethyl cellulose.
90. The method of embodiment 80, wherein the polymer is a synthetically derived polymer.
91. The method of embodiment 80 or 90, wherein the polymer is polyvinyl alcohol.
92. A method of preparing a crosslinker solution concentrate, comprising the steps of:
   a. blending water and a crosslinker; and
   b. containing the crosslinker solution in a resistant package that is transport and storage resistant.
93. The method of embodiment 92, wherein the crosslinker is a chemical crosslinker.
94. The method of embodiment 92 or 93, wherein a functional group of the crosslinker is aldehyde or carbodiimide.
95. The method of embodiment 94, wherein the aldehyde comprises glutaraldehyde or glyoxal.
96. The method of embodiment 94, wherein the carbodiimide comprises 1-Ethyl-3-(3-dimethylaminopropyl) carbodiimide.
97. The method of embodiment 92, wherein the crosslinker is a physical crosslinker.
98. The method of embodiment 92 or 97, wherein a functional group of the crosslinker is divalent metal or trivalent metal.
99. The method of embodiment 98, wherein the divalent metal is selected from the group consisting of Ca²⁺, Mg²⁺, Zn²⁺, Sr²⁺, Ba²⁺, Cu²⁺, and Fe²⁺.
100. The method of embodiment 98, wherein the trivalent metal is selected from the group consisting of Fe³⁺, Cr³⁺, and Al³⁺.
101. The method of embodiment 99, wherein the Ca²⁺ is calcium carbonate or calcium chloride.
102. The method of embodiment 100, wherein the Fe³⁺ is ferric iron chloride or ferric iron sulphate.
103. A foamed hydrogel composition, comprising:
   a. a polymer selected from the group consisting of polyvinyl alcohol, protein, lignin, denatured collagen, chitosan, starch, alginate, pectin, carrageenan, and cellulose;
   b. a crosslinker selected from the group consisting of glutaraldehyde, glyoxal, 1-Ethyl-3-(3-dimethylaminopropyl) carbodiimide, calcium carbonate, calcium chloride, ferric iron chloride, and ferric iron sulphate; and
   c. compressed gas capable of foaming a hydrogel into a foamed hydrogel.
104. The foamed hydrogel composition of embodiment 103, wherein the lignin comprises oxidized derivatives of lignin.
105. The foamed hydrogel composition of embodiment 103, wherein the lignin comprises kraft lignin, alkali lignin, or lignosulphonate.
106. The foamed hydrogel composition of embodiment 103, wherein the protein comprises soy protein, whey protein, hydrolyzed derivates of soy protein, or hydrolyzed derivates of whey protein.
107. The foamed hydrogel composition of embodiment 103, wherein the carrageenan comprises kappa carrageenan, iota carrageenan, or lambda carrageenan.
108. The foamed hydrogel composition of embodiment 103, wherein the cellulose comprises ester and, or ether derivates.
109. The foamed hydrogel composition of embodiment 108, wherein the ether derivatives of the cellulose comprises carboxymethyl cellulose, hydroxypropyl methyl cellulose, methyl cellulose, or hydroxyethyl cellulose.
110. The foamed hydrogel composition of any one of embodiments 103-109, wherein the polymer is biodegradable.
111. The foamed hydrogel composition of any one of embodiments 103-110, wherein the foamed hydrogel is biodegradable.
112. The foamed hydrogel composition of any one of embodiments 103-111, wherein the foamed hydrogel has an improved foaming ability with an increased mechanical strength, thereby holding onto a target.
113. The foamed hydrogel composition of embodiment 112, wherein the target is a plant, a crop, or an area in which the plant or crop is growing.
114. A foamed hydrogel composition, comprising:
   a. a polymer, which is a chitosan;
   b. a crosslinker selected from the group consisting of glutaraldehyde, glyoxal, 1-Ethyl-3-(3-dimethylaminopropyl) carbodiimide, calcium carbonate, calcium chloride, ferric iron chloride, and ferric iron sulphate; and
   c. compressed gas.
115. A foamed hydrogel composition, comprising:
   a. a polymer, which is a denatured collagen;
   b. a crosslinker selected from the group consisting of glutaraldehyde, glyoxal, 1-Ethyl-3-(3-dimethylaminopropyl) carbodiimide, calcium carbonate, calcium chloride, ferric iron chloride, and ferric iron sulphate; and
   c. compressed gas.
116. A foamed hydrogel composition, comprising:
   a. a polymer, which is a chitosan;
   b. a crosslinker, which is glutaraldehyde; and
   c. compressed gas.
117. A foamed hydrogel composition, comprising:
   a. a polymer, which is a denatured collagen;
   b. a crosslinker, which is glutaraldehyde; and
   c. compressed gas.
118. A foamed hydrogel composition, comprising:
   a. a polymer, which is a denatured collagen;
   b. a crosslinker, which is 1-Ethyl-3-(3-dimethylaminopropyl) carbodiimide; and
   c. compressed gas.

What is claimed is:

1. A foamed hydrogel composition, comprising:
a. a polymer;
b. a crosslinker; and
c. compressed gas capable of foaming a hydrogel into a foamed hydrogel.

2. The foamed hydrogel composition of claim 1, wherein a functional group of the polymer is selected from the group consisting of —NH₂, —COOH, and —OH.

3. The foamed hydrogel composition of claim 1, wherein the polymer is a naturally derived polymer.

4. The foamed hydrogel composition of claim 1 or 3, wherein the polymer is selected from the group consisting of protein, lignin, denatured collagen, chitosan, starch, alginate, pectin, carrageenan, and cellulose.

5. The foamed hydrogel composition of claim 4, wherein the lignin comprises oxidized derivatives of lignin.

6. The foamed hydrogel composition of claim 4, wherein the lignin comprises kraft lignin, alkali lignin, or lignosulphonate.

7. The foamed hydrogel composition of claim 4, wherein the protein comprises soy protein, whey protein, hydrolyzed derivates of soy protein, or hydrolyzed derivates of whey protein.

8. The foamed hydrogel composition of claim 4, wherein the carrageenan comprises kappa carrageenan, iota carrageenan, or lambda carrageenan.

9. The foamed hydrogel composition of claim 4, wherein the cellulose comprises ester and, or ether derivates.

10. The foamed hydrogel composition of claim 9, wherein the ether derivatives of the cellulose comprises carboxymethyl cellulose, hydroxypropyl methyl cellulose, methyl cellulose, or hydroxyethyl cellulose.

11. The foamed hydrogel composition of claim 1, wherein the polymer is a synthetically derived polymer.

12. The foamed hydrogel composition of claim 1 or 11, wherein the polymer is polyvinyl alcohol.

13. The foamed hydrogel composition of claim 1, wherein the crosslinker is a chemical crosslinker.

14. The foamed hydrogel composition of claim 1 or 13, wherein a functional group of the crosslinker is aldehyde or carbodiimide.

15. The foamed hydrogel composition of claim 14, wherein the aldehyde comprises glutaraldehyde or glyoxal.

16. The foamed hydrogel composition of claim 14, wherein the carbodiimide comprises 1-Ethyl-3-(3-dimethylaminopropyl) carbodiimide.

17. The foamed hydrogel composition of claim 1, wherein the crosslinker is a physical crosslinker.

18. The foamed hydrogel composition of claim 1 or 17, wherein a functional group of the crosslinker is divalent metal or trivalent metal.

19. The foamed hydrogel composition of claim 18, wherein the divalent metal is selected from the group consisting of Ca²⁺, Mg²⁺, Zn²⁺, Sr²⁺, Ba²⁺, Cu²⁺, and Fe²⁺.

20. The foamed hydrogel composition of claim 18, wherein the trivalent metal is selected from the group consisting of Fe³⁺—, Cr³⁺, and Al³⁺.

21. The foamed hydrogel composition of claim 19, wherein the Ca²⁺ is calcium carbonate or calcium chloride.

22. The foamed hydrogel composition of claim 20, wherein the Fe³⁺ is ferric iron chloride or ferric iron sulphate.

23. The foamed hydrogel composition of any one of claims 1-22, wherein the polymer is biodegradable.

24. The foamed hydrogel composition of any one of claims 1-23, wherein the foamed hydrogel is biodegradable.

25. The foamed hydrogel composition of any one of claims 1-24, wherein the foamed hydrogel has an improved foaming ability with an increased mechanical strength, thereby holding onto a target.

26. The foamed hydrogel composition of claim 25, wherein the target is a plant, a crop, or an area in which the plant or crop is growing.

27. The foamed hydrogel composition of any one of claims 1-26, wherein a 6 cm thick cylinder of the foamed hydrogel hold onto ¼ inch wood dowel placed 4 cm from a slick vinyl coated board set that is 70° from vertical, for about 30 minutes without deforming significantly.

28. The foamed hydrogel composition of claim 1, wherein the hydrogel has a water content of about 80% to about 99% by weight, when gas porosity is less than 1% by volume.

29. The foamed hydrogel composition of claim 1, wherein the foamed hydrogel has a gas porosity of about 50% to about 99% by volume.

30. The foamed hydrogel composition of claim 1, wherein the foamed hydrogel has gas bubbles with an average diameter of about 0.1 mm to about 5 cm.

31. The foamed hydrogel composition of claim 1, wherein the crosslinker reacts with the polymer to form a covalent bond in ambient conditions from about-10° C. to about 40° C. and relative humidity between about 10% to 100%.

32. The foamed hydrogel composition of claim 1, wherein the polymer and the crosslinker have a reaction half-life of 1 second to 600 seconds.

33. The foamed hydrogel composition of claim 1, wherein the hydrogel has a polymer concentration of about 1% to about 10% by weight, when gas porosity is less than 1%.

34. The foamed hydrogel composition of claim 1, wherein the hydrogel has a polymer concentration of about 0.5% to about 5% by weight, when gas porosity is less than 1%.

35. The foamed hydrogel composition of claim 1, wherein the hydrogel has a polymer concentration of about 0.1% to about 2% by weight, when gas porosity is less than 1%.

36. The foamed hydrogel composition of claim 1, wherein the hydrogel has a polymer concentration of about 3.5% to about 10% by weight, when gas porosity is less than 1%.

37. The foamed hydrogel composition of claim 1, wherein the hydrogel has a polymer concentration of about 2% to about 7.5% by weight, when gas porosity is less than 1%.

38. The foamed hydrogel composition of claim 1, wherein the hydrogel has a polymer concentration of about 3.5% to about 15% by weight, when gas porosity is less than 1%.

39. The foamed hydrogel composition of claim 1, wherein the hydrogel has a polymer concentration of about 3.5% to about 25% by weight, when gas porosity is less than 1%.

40. The foamed hydrogel composition of claim 1, wherein the hydrogel has a crosslinker concentration of about 1% to about 10% by weight, when gas porosity is less than 1%.

41. The foamed hydrogel composition of claim 1, wherein the hydrogel has a crosslinker concentration of about 0.1% to about 1% by weight, when gas porosity is less than 1%.

42. The foamed hydrogel composition of claim 1, wherein the hydrogel has a crosslinker concentration of about 0.1% to about 3.5% by weight, when gas porosity is less than 1%.

43. The foamed hydrogel composition of claim 1, wherein the hydrogel has a crosslinker concentration of about 0.1% to about 5% by weight, when gas porosity is less than 1%.

44. The foamed hydrogel composition of claim 1, wherein the hydrogel has a crosslinker concentration of about 1% to about 5% by weight, when gas porosity is less than 1%.

45. The foamed hydrogel composition of claim 1, wherein the hydrogel has a crosslinker concentration of about 1% to about 15% by weight, when gas porosity is less than 1%.

46. A method of protecting a plant from an abiotic stressor, comprising: applying the foamed hydrogel composition of claim 1 to a plant or an area in which the plant or crop is growing.

47. The method of claim 46, wherein the abiotic stressor is smoke, sun exposure, or frost.

48. A method of protecting a plant from a biotic stressor, comprising: applying the foamed hydrogel composition of claim 1 to a plant or an area in which the plant is growing.

49. The method of claim 48, wherein the biotic stressor is a fungus, a bacterium, a pathogen, an insect, or a pest.

50. A method of generating a foamed hydrogel, comprising the steps of:
a. providing a polymer solution comprising water and a polymer;
b. providing a crosslinking solution comprising water and a crosslinking agent; and
c. mixing the polymer solution, the crosslinking solution, and a gas to form a foamed hydrogel.

51. The method of claim 50, wherein step (c) is performed as follows:
(i) mixing the polymer solution with a compressed gas; and
(ii) mixing the compressed gas-polymer solution with the crosslinking solution.

52. The method of claim 50, wherein step (c) is performed as follows:
(i) mixing the polymer solution with the crosslinking solution; and
(ii) mixing the polymer-crosslinker solution with compressed gas.

53. The method of claim 50, wherein step (c) is performed as follows:
(i) mixing the crosslinker solution with a compressed gas; and
(ii) mixing the compressed gas-crosslinker solution with the polymer solution.

54. The method of claim 50, wherein the foamed hydrogel is applied to a target within 500 seconds after step (c) is done.

55. The method of claim 50, wherein the target is a plant, a crop, or an area in which the plant or crop is growing.

56. The method of claim 50, wherein a functional group of the polymer is selected from the group consisting of —NH₂, —COOH, and —OH.

57. The method of claim 50, wherein the polymer is a naturally derived polymer.

58. The method of claim 50 or 57, wherein the polymer is selected from the group consisting of protein, lignin, denatured collagen, chitosan, starch, alginate, pectin, carrageenan, and cellulose.

59. The method of claim 58, wherein the lignin comprises oxidized derivatives of lignin.

60. The method of claim 58, wherein the lignin comprises kraft lignin, alkali lignin, or lignosulphonate.

61. The method of claim 58, wherein the protein comprises soy protein, whey protein, hydrolyzed derivates of soy protein, or hydrolyzed derivates of whey protein.

62. The method of claim 58, wherein the carrageenan comprises kappa carrageenan, iota carrageenan, or lambda carrageenan.

63. The method of claim 58, wherein the cellulose comprises ester and, or ether derivates.

64. The method of claim 63, wherein the ether derivatives of the cellulose comprises carboxymethyl cellulose, hydroxypropyl methyl cellulose, methyl cellulose, or hydroxyethyl cellulose.

65. The method of claim 50, wherein the polymer is a synthetically derived polymer.

66. The method of claim 50 or 65 wherein the polymer is polyvinyl alcohol.

67. The method of claim 50, wherein the crosslinker is a chemical crosslinker.

68. The method of claim 50 or 67, wherein a functional group of the crosslinker is aldehyde or carbodiimide.

69. The method of claim 68, wherein the aldehyde comprises glutaraldehyde or glyoxal.

70. The method of claim 68, wherein the carbodiimide comprises 1-Ethyl-3-(3-dimethylaminopropyl) carbodiimide.

71. The method of claim 50, wherein the crosslinker is a physical crosslinker.

72. The method of claim 50 or 71, wherein a functional group of the crosslinker is divalent metal or trivalent metal.

73. The method of claim 72, wherein the divalent metal is selected from the group consisting of Ca²⁺, Mg²⁺, Zn²⁺, Sr²⁺, Ba²⁺, Cu²⁺, and Fe²⁺.

74. The method of claim 72, wherein the trivalent metal is selected from the group consisting of Fe³⁺, Cr³⁺, and Al³⁺.

75. The method of claim 73, wherein the Ca²⁺ is calcium carbonate or calcium chloride.

76. The method of claim 74, wherein the Fe³⁺ is ferric iron chloride or ferric iron sulphate.

77. The method of any one of claims 50-76, wherein the polymer is biodegradable.

78. The method of any one of claims 50-77, wherein the foamed hydrogel is biodegradable.

79. The method of any one of claims 50-78, wherein the foamed hydrogel has an improved foaming ability with an increased mechanical strength, thereby holding onto a plant or an area in which the plant is growing.

80. A method of preparing a polymer solution concentrate, comprising the steps of:
a. blending water and a polymer; and
b. containing the polymer solution in a resistant package that is transport and storage resistant.

81. The method of claim 80, wherein a functional group of the polymer is selected from the group consisting of —NH₂, —COOH, and —OH.

82. The method of claim 80, wherein the polymer is a naturally derived polymer.

83. The method of claim 80 or 82, wherein the polymer is selected from the group consisting of protein, lignin, denatured collagen, chitosan, starch, alginate, pectin, carrageenan, and cellulose.

84. The method of claim 83, wherein the lignin comprises oxidized derivatives of lignin.

85. The method of claim 83, wherein the lignin comprises kraft lignin, alkali lignin, or lignosulphonate.

86. The method of claim 83, wherein the protein comprises soy protein, whey protein, hydrolyzed derivates of soy protein, or hydrolyzed derivates of whey protein.

87. The method of claim 83, wherein the carrageenan comprises kappa carrageenan, iota carrageenan, or lambda carrageenan.

88. The method of claim 83, wherein the cellulose comprises ester and, or ether derivates.

89. The method of claim 88, wherein the ether derivatives of the cellulose comprises carboxymethyl cellulose, hydroxypropyl methyl cellulose, methyl cellulose, or hydroxyethyl cellulose.

90. The method of claim 80, wherein the polymer is a synthetically derived polymer.

91. The method of claim 80 or 90, wherein the polymer is polyvinyl alcohol.

92. A method of preparing a crosslinker solution concentrate, comprising the steps of:
a. blending water and a crosslinker; and
b. containing the crosslinker solution in a resistant package that is transport and storage resistant.

93. The method of claim 92, wherein the crosslinker is a chemical crosslinker.

94. The method of claim 92 or 93, wherein a functional group of the crosslinker is aldehyde or carbodiimide.

95. The method of claim 94, wherein the aldehyde comprises glutaraldehyde or glyoxal.

96. The method of claim 94, wherein the carbodiimide comprises 1-Ethyl-3-(3-dimethylaminopropyl) carbodiimide.

97. The method of claim 92, wherein the crosslinker is a physical crosslinker.

98. The method of claim 92 or 97, wherein a functional group of the crosslinker is divalent metal or trivalent metal.

99. The method of claim 98, wherein the divalent metal is selected from the group consisting of Ca²⁺, Mg²⁺, Zn²⁺, Sr²⁺, Ba²⁺, Cu²⁺, and Fe²⁺.

100. The method of claim 98, wherein the trivalent metal is selected from the group consisting of Fe³⁺, Cr³⁺, and Al³⁺.

101. The method of claim 99, wherein the Ca²⁺ is calcium carbonate or calcium chloride.

102. The method of claim 100, wherein the Fe³⁺ is ferric iron chloride or ferric iron sulphate.
